(19) United States
(12) Patent Application Publication
(10) Pub. No.: US 2006/0143428 A1
(43) Pub. Date: Jun. 29, 2006

(54) Semiconductor signal processing device

(75) Inventors: Hideyuki Noda, Tokyo (JP); Kazutami Arimoto, Tokyo (JP); Katsumi Dosaka, Tokyo (JP); Kazunori Saito, Tokyo (JP)

Correspondence Address: MCDERMOTT WILL & EMERY LLP, 600 13TH STREET, N.W., WASHINGTON, DC, 20005-3096, US

(73) Assignee: RENESAS TECHNOLOGY CORP.

(21) Appl. No.: 11/282,714

(22) Filed: Nov. 21, 2005

(30) Foreign Application Priority Data
Dec. 10, 2004 (JP) 2004-358719 (P)

(51) Int. Cl. G06F 15/00; G06F 7/48

(52) U.S. Cl. 712/10; 708/190; 708/200

(57) ABSTRACT

An orthogonal memory for transforming arrangements of system bus data and processing data is placed between a system bus interface and a memory cell mat storing the processing data. The orthogonal memory includes two-port memory cells, and changes data train transferred in a bit parallel and word serial fashion into a data train of word parallel and bit serial data. Data transfer efficiency in a signal processing device performing parallel operational processing can be increased without impairing parallelism of the processing.

### BACKGROUND OF THE INVENTION

1. Field of the Invention

The present invention relates to a semiconductor signal processing device, and particularly to a construction of an integrated circuit device for signal processing which can perform fast arithmetic processing of a large quantity of data, using a semiconductor memory. More particularly, the invention relates to a construction for efficiently transferring data to and/or from a semiconductor memory storing arithmetic data.

2. Description of the Background Art

In accordance with widespread use of portable terminal equipments in recent years, digital signal processing for processing a large quantity of data such as audio and image data at high speed have become more important. Such digital signal processing generally involves a DSP (Digital Signal Processor) as a dedicated semiconductor device. Data processing such as filter processing is performed in digital signal processing of the audio and image data. Such processing specifically includes arithmetic processing of repeating product-sum operations in many cases. Therefore, DSP is generally constructed with a multiplying circuit, an adding circuit and registers for storing data before and after arithmetic operations. By utilizing the dedicated DSP, the product-sum operation can be executed in one machine cycle, and thus fast arithmetic processing can be implemented.

A prior art reference 1 (Japanese Patent Laying-Open No. 06-324862) discloses a construction which utilizes a register file when performing the product-sum operation. In the construction disclosed in this prior art reference 1, an arithmetic and logic unit reads and adds operand data of two terms stored in the register file, and the result data of the addition is written into the register file via a write data register. A write address and a read address are concurrently applied to the register file, and writing and reading of the data are performed in parallel. The prior art reference 1 intends to reduce the processing time, as compared with a construction in which a data write cycle and a data read cycle are provided separately from each other for arithmetic processing.

A prior art reference 2 (Japanese Patent Laying-Open No. 05-197550) discloses a construction aiming at fast processing of a large quantity of data. The construction disclosed in the prior art reference 2 has a plurality of arithmetic devices arranged in parallel, and each arithmetic device is internally provided with a memory. Each arithmetic device is configured to produce a memory address individually and separately so that parallel arithmetic operations may be performed fast.

A prior art reference 3 (Japanese Patent Laying-Open No. 10-074141) discloses a signal processing device aiming at fast execution of processing such as DCT (Discrete Cosine Transform) of image data. In the construction disclosed in the prior art reference 3, since image data is input in a manner of bit parallel and word serial, i.e., on a word-by-word basis (a pixel data at a time), data is written into a memory array after being converted to word-parallel and bit-serial data train by a serial-parallel converter circuit. The data are transferred to arithmetic and logic units (ALU) arranged corresponding to the memory array for parallel processing. The memory array is divided into blocks corresponding to image data blocks, and the image data forming the corresponding image block is stored in each block for each row of the memory array on a word-by-word basis.

In the construction disclosed in the prior art reference 3, data is transferred between the memory array and the corresponding arithmetic and logic units on a word-by-word basis (i.e., data corresponding to one pixel at a time). The arithmetic and logic unit corresponding to each block executes the same processing on the word transferred thereto so that filter processing such as discrete cosine transform may be executed fast. A result of the arithmetic processing is written into the memory array again, and the parallel-serial conversion is performed again to convert the bit-serial and word-parallel data to bit-parallel and word-serial data. The data thus converted is successively output for each line. In an ordinary processing, bit positions of the data are not changed, and the arithmetic and logic unit executes the ordinary arithmetic processing on a plurality of data pieces in parallel.

A prior art reference 4 (Japanese Patent Laying-Open No. 2003-114797) discloses a data processing device aiming at parallel execution of a plurality of different arithmetic operations. In this construction disclosed in this prior art reference 4, a plurality of logic modules each allotted a limited function are connected to data memories of a multi-port construction. According to the connection between these logic modules and the multi-port data memories, the logic modules are connected to restricted data memories and the ports of the multi-port data memories, and an address region, in which each logic module is allowed to accesses the multi-port data memory for data reading and writing, is restricted. A result of the arithmetic operation performed by each logic module is written into a memory to which access is allowed for the logic module, and the data is successively transferred via these multi-port memories and the logic modules so that the data processing is performed in a pipelining fashion.

When the quantity of data to be processed is extremely large, it is difficult to improve dramatically the performance even when a dedicated DSP is used. For example, when ten thousand sets of data items are to be processed, even through each data set can be operated in one machine cycle, at least ten thousand cycles are required for the arithmetic operation. Therefore, in the construction performing the product-sum operation with the register file disclosed in the prior art reference 1, data processing is performed in serial, and therefore takes a long time in proportion to the quantity of data although each data set can be processed fast. Therefore, fast processing is impossible. When the dedicated DSP as described above is used, the processing performance significantly depends on an operation frequency so that power consumption increases when high priority is given to fast processing.

The construction with the register file and the arithmetic and logic unit as disclosed in the prior art reference 1 is designed dedicatedly to a specific application in many cases, and the arithmetic and logic unit is fixed in the processing bit width, a construction and others. For using such construction for another application, therefore, it is necessary to redesign the bit width and the construction of arithmetic and logic unit, leading to a problem that the construction cannot be flexibly applied to a plurality of arithmetic processing applications.

In the construction disclosed in the prior art reference 2, each arithmetic and logic unit is internally provided with the memory, and the respective arithmetic and logic units access different memory address regions for processing. However, the data memory and the associated arithmetic and logic unit are arranged in different regions, and the address must be transferred between the arithmetic and logic unit and the memory in the logic module for performing the data access so that data transfer takes a time. Therefore, the machine cycle cannot be shortened, and fast processing is impossible.

The construction disclosed in the prior art reference 3 aims at the speed up of a processing such as the discrete cosine transform of image data. In this construction, the pixel data for one line on the screen is stored in the memory cells in one row, and the processing is effected in parallel on image blocks aligned in the row direction. Therefore, the memory array has a huge size if the number of pixels in each line increases for higher definition of images. For example, even when data of one pixel is formed 8 bits, and one line includes 512 pixels, one line in the memory array includes the memory cells of 8·512=4 K bits so that a row select line (word line) connected to the memory cells in each row bear an increased load. Therefore, it is impossible to perform fast selection of the memory cells and fast transfer of the data between the arithmetic and logic unit and the memory cells, and therefore fast processing cannot be achieved.

Although the prior art reference 3 discloses a construction in which memory cell arrays are arranged on the opposite sides of an arithmetic and logic unit group, it is silent with a specific structure of the memory cell array. In addition, the prior art reference 3 discloses the construction in which arithmetic and logic units are arranged in an array form, but specific manner of arrangement of the arithmetic and logic unit group is neither disclosed nor suggested.

The prior art reference 4 arranges a plurality of multi-port data memories and a plurality of low-function arithmetic and logic units (ALUs) of which access regions are restricted to the associated multi-port data memories. However, the arithmetic and logic units (ALUs) are arranged in different-regions from those of the memories, and the data cannot be transferred fast due to interconnection capacitances and gate delay at interfaces. Therefore, even if the pipelining processing is executed, the machine cycle of this pipelining cannot be shortened.

Neither of these prior art references 1 to 4 discusses a manner of accommodating the case where the data to be arithmetically operated has a different word configuration.

The inventor et al. of the present application have already devised a construction which can perform fast arithmetic processing even when the data to be arithmetically operated has a different word configuration (Japanese Patent Application Nos. 2004-171658 and 2004-282014). In this signal processing device, an arithmetic and logic unit is arranged corresponding to each column (in a bit line extending direction; entry) in a memory array, data to be processed is stored in each entry and each arithmetic and logic unit performs a arithmetic processing in a bit serial fashion.

According to this construction, the operation target data is stored on the entry corresponding to each colunm, and is operated in the bit serial fashion. Therefore, even when the data are different in bit width, this merely causes increase in operational processing time and the data of a different word configuration can be easily operated.

Further, the above-described construction is configured to execute in parallel the processing in the arithmetic and logic units, and the arithmetic and logic units equal in number to the entries (columns) simultaneously execute the parallel processing. Therefore, the processing time can be shorter than that in the case in which the data are sequentially processed. For example, it is assumed that the number of entries is 1024, a binary operation is effected on 8-bit data and each of operations of transferring each of two-term data, arithmetically processing thereof and storing an operational result requires one machine cycle. In this case, the transferring, operational processing and storing require 8×2, 8 and 8 cycles, respectively, and thus require 32 operation cycles in total (and additional one cycle for storage of carry). However, the parallel operational processing is executed in the 1024 entries, and therefore the time required for the operational processing can be significantly reduced as compared with a construction of sequentially operating 1024 data sets.

However, for implementing the fast processing by efficiently utilizing the advantageous feature of the prior application, or the parallelism of processing, it is required to perform efficient data transfer to the memory regions storing data before and after an operational processing. Further, the circuitry for performing the data transfer must achieve a reduced layout area and low power consumption. In view of these points, the parallel arithmetic signal processing device of the group of the inventor and others may have still room for improvement.

### SUMMARY OF THE INVENTION

An object of the invention is to provide a semiconductor signal processing device which can efficiently perform an operational processing.

Another object of the invention is to provide a semiconductor signal processing device in which a memory array and an arithmetic and logic unit group are integrated, and operational data can be transferred to the memory regions of the memory array.

A semiconductor signal processing device according to a first aspect of the invention includes a fundamental operational block including a memory cell mat divided into a plurality of entries each having a plurality of memory cells aligned in a first direction, and a plurality of operational processing units, arranged corresponding to the respective entries of the memory cell mat, each being capable of effecting an operational processing on data of a corresponding entry and storing a result of the operational processing in the corresponding entry. Each of the entries stores bits of same data.

The semiconductor signal processing device according to the first aspect of the invention further includes an internal data transfer bus for transferring the data with the memory array of the fundamental operational block, an interface unit providing an external interface for the device, and a data arrangement transforming circuit arranged between the interface unit and the internal data bus for rearranging the data between the interface unit and the internal data transfer bus. The internal data transfer bus has a larger bit width than the transfer data outside the device.

The data arrangement transforming circuit includes a plurality of first word lines extending in the first direction of extension of each of the entries, a plurality of second word lines arranged extending in a second direction crossing the first direction, a plurality of first bit line pairs arranged extending in the second direction, a plurality of second bit line pairs arranged extending in the first direction and a plurality of SRAM (Static Random Access Memory) cells aligned in the first and second directions into an array form, and located corresponding to crossings of the first word lines and the first bit line pairs and crossings of the second word lines and the second bit line pairs. The first word lines are arranged corresponding to the second bit line pairs, and the second word lines are arranged corresponding to the first bit line pairs.

The data arrangement transforming circuit further includes a first cell selecting unit for selecting a first word line and a fist bit line pair when data is transferred with the interface unit, and a second cell selecting unit for selecting a second word line and a second bit line pair when data is transferred with the internal data transfer bus.

A semiconductor signal processing device according to a second aspect of the invention includes a fundamental operational block including a memory array divided into a plurality of entries each having a plurality of memory cells aligned in a first direction, and a plurality of operational processing units, arranged corresponding to the entries of the memory array, each being capable of effecting an operational processing on data of the corresponding entry and storing a result of the operational processing in the corresponding entry. Each of the entries stores bits of same data.

The semiconductor signal processing device according to the second aspect of the invention further includes a data arrangement transforming circuit arranged corresponding to the memory cell mat for rearranging the data between an internal data transfer bus and said memory cell mat.

The data arrangement transforming circuit includes a plurality of first word lines arranged corresponding to the entries, a plurality of second word lines arranged extending in a second direction orthogonal to said first direction, a plurality of first bit line pairs arranged extending in the second direction, a plurality of second bit line pairs arranged extending in said first direction and corresponding to the entries, and a plurality of SRAM (Static Random Access Memory) cells aligned in the first and second directions into an array form and located corresponding to crossings between the first word lines and the first bit line pairs and crossings between the second word lines and the second bit line pairs. The first word lines are arranged corresponding to the second bit line pairs, and the second word lines are arranged corresponding to said first bit line pairs.

The data arrangement transforming circuit further includes a first cell selecting unit for selecting a first word line and a fist bit line pair when data is transferred with the internal data bus; a second cell selecting unit for selecting a second word line and a second bit line pair when data is transferred with the internal data bus; and a data transfer unit for transferring the data between each of the entries and a corresponding second bit line.

The first and second word lines are orthogonal to each other, and therefore orthogonal transformation can be performed between the data array upon selection of a first word line and the data array upon section of a second word line. Therefore, at the time of data transfer to or from the memory cell mat, the data word can be transferred in a fashion of bit serial and data word parallel. Also, upon data transfer with an external unit or upon data transfer with an internal data bus, the data can be transferred in a fashion of bit parallel and data word serial. Thus, the data transfer can be performed while maintaining consistency between external and internal sides so that fast data transfer can be achieved to reduce the time required for the data transfer with the memory cell mat.

Since the data arrangement transformation utilizes the SRAM cells, it is possible to provide a data arrangement transforming circuit achieving a small layout area and fast access.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically shows by way of example a construction of a processing system including a semiconductor signal processing device according to the invention.

FIG. 2 schematically illustrates a calculation operation of a main computational circuit shown in FIG. 1.

FIG. 3 shows by way of example a structure of a memory cell included in a memory cell mat shown in FIG. 2.

FIG. 4 illustrates by way of example a specific calculation operation of a main computational circuit in FIG. 2.

FIG. 5 shows a specific construction of the main computational circuit shown in FIG. 1.

FIG. 6 schematically illustrates a flow of data at a time of data setting in the main computational circuit.

FIG. 7 schematically shows a construction of a processing system including a semiconductor signal processing device according to a first embodiment of the invention.

FIG. 8 schematically shows a construction of an orthogonal transforming circuit shown in FIG. 7.

FIG. 9 is a flowchart illustrating an operation of the orthogonal transforming circuit shown in FIG. 8.

FIG. 10 schematically illustrates a flow of data between an external side and the memory cell mat in the main computational circuit in a construction employing the orthogonal transforming circuit shown in FIG. 8.

FIG. 11 shows by way of example a construction of a memory cell in an orthogonal memory shown in FIG. 8.

FIG. 12 shows a specific construction of the orthogonal transforming circuit shown in FIG. 8.

FIG. 13 schematically illustrates a flow of data of the orthogonal memory shown in FIG. 12.

FIG. 14 is a signal waveform diagram representing a data transfer operation between the orthogonal memory and the memory cell mat in the main computational circuit shown in FIG. 12.

FIG. 15 schematically illustrates a flow of data in the orthogonal memory as represented in the signal waveform diagram of FIG. 14.

FIG. 16 is a signal waveform diagram representing a data transfer operation between the orthogonal memory shown in FIG. 12 and a system bus.

FIG. 17 schematically illustrates a flow of data of the orthogonal memory represented in the signal waveform diagram of FIG. 16.

FIG. 18 schematically shows a construction of a main computational circuit according to a second embodiment of the invention.

FIG. 19 schematically illustrates a flow of data upon data setting in the main computational circuit shown in FIG. 18.

FIG. 20 schematically illustrates a flow of data at a time of a calculation operation of the main computational circuit shown in FIG. 18.

FIG. 21 schematically illustrates a flow of data upon data output of the main computational circuit shown in FIG. 18.

FIG. 22 schematically shows by way of example a construction of a portion generating addresses for a memory cell mat of the main computational circuit shown in FIG. 18.

FIG. 23 shows by way of example a system architecture utilizing the main computational circuit shown in FIG. 21.

FIG. 24 schematically shows another example of a system architecture employing the main computational circuit shown in FIG. 18.

FIG. 25 schematically shows a construction of a main computational circuit according to a third embodiment of the invention.

FIG. 26 is a flowchart representing an operation upon data setting in an orthogonal two-port memory cell mat in the main computational circuit shown in FIG. 25.

FIG. 27 schematically illustrates a correspondence of sense amplifiers and write drivers of the main computational circuit shown in FIG. 25 with respect to bit line pairs.

FIG. 28 is a flowchart representing an operation upon output of calculation result data of the main computational circuit shown in FIG. 25.

FIG. 29 schematically shows a construction of a semiconductor signal processing device according to a fourth embodiment of the invention.

FIG. 30 schematically shows a construction of a semiconductor signal processing device according to a fifth embodiment of the invention.

FIG. 31 schematically shows by way of example a construction of a switch macro shown in FIG. 30.

FIG. 32 schematically illustrates a manner of data storage in an orthogonal memory according to a sixth embodiment of the invention.

FIG. 33 schematically shows a construction of an address generating unit for the orthogonal memory shown in FIG. 32.

FIG. 34 schematically illustrates another manner of data storage in the orthogonal memory shown in FIG. 32.

FIGS. 35A and 35B schematically show an internal construction of an orthogonal memory according to the fifth embodiment of the invention.

FIG. 36 schematically shows a data flow of the orthogonal memory shown in FIGS. 35A and 35B.

FIGS. 37A-37C schematically show data transfer of a semiconductor signal processing device according to a seventh embodiment of the invention.

FIG. 38 schematically shows a construction of a unit for generating an address upon data transfer in FIGS. 37A-37C.

FIG. 39 schematically shows a construction of a semiconductor signal processing device according to an eighth embodiment of the invention.

FIG. 40 illustrates a data transfer operation of an orthogonal memory shown in FIG. 39.

FIG. 41 schematically illustrates data transfer between the orthogonal memory in the system shown in FIG. 39 and the main computational circuit (operational array mat).

FIG. 42 shows a construction of an orthogonal memory cell according to a ninth embodiment of the invention.

FIG. 43 schematically shows a whole construction of an orthogonal memory according to the ninth embodiment of the invention.

FIG. 44 is a signal waveform diagram representing an operation for data retrieval in the orthogonal memory shown in FIG. 43.

### DESCRIPTION OF THE PREFERRED EMBODIMENTS

[Whole Construction of Operation Module Employing the Invention]

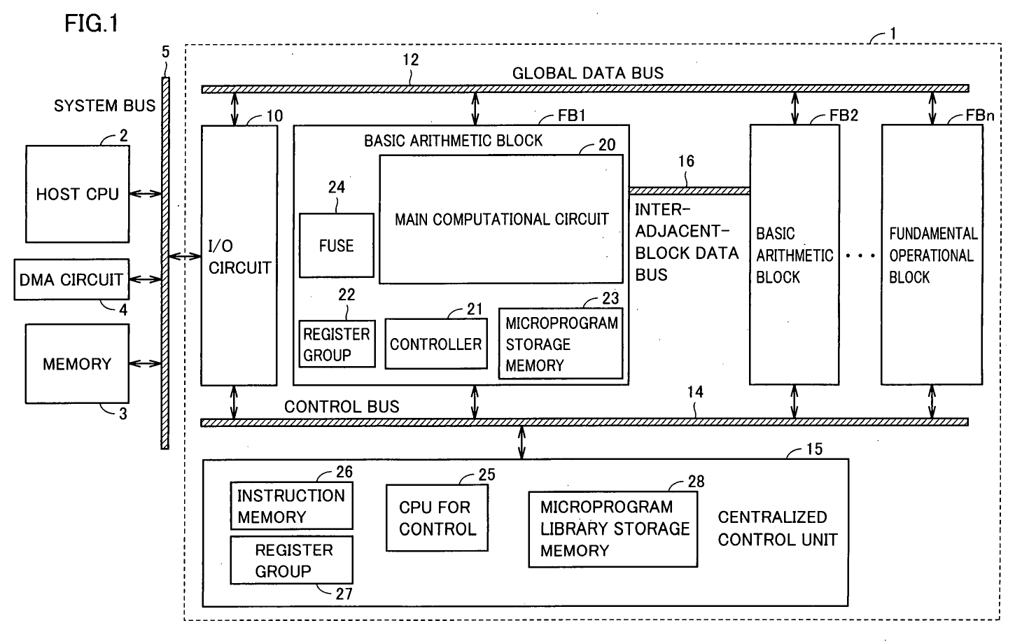

FIG. 1 schematically shows a construction of an operational function module to which the invention is applied. A patent application relating to a specific construction of this operational function module 1 is already filed, and the specific construction is discussed in the specification of the application already filed as mentioned previously. However, for facilitating understanding of a construction and a function of a data transfer unit in this invention, description will now be briefly given on the construction and operation of the operational function module (operational device) to which the invention is applied.

In FIG. 1, an operational function module 1 is coupled to a host CPU (Central Processing Unit) 2, a DMA circuit (Direct Memory Access Control Circuit) 4 and a memory 3 via a system bus 5, to construct a signal processing system. Host CPU 2 performs control of processing in operational function module 1, control of the whole system and data processing. Memory 3 is utilized as a main storage of the system, and stores required various data. As will be described later, memory 3 includes a memory of a large capacity, a fast memory and a nonvolatile memory.

DMA circuit 4 is used for directly accessing memory 3 without control by host CPU 2. Under the control of DMA circuit 4, data can be transferred between memory 3 and arithmetic function module 1, and direct access to arithmetic function module 1 can be implemented.

Operational function module 1 includes a plurality of fundamental operational blocks FB1-FBn provided in parallel, an input/output circuit 10 for transferring data and instructions to and from system bus 5, and a centralized control unit 15 for controlling operational processing within operational function module 1.

Fundamental operational blocks FB1-FBn and input/output circuit 10 are coupled to a global data bus 10, and centralized control unit 15, input/output circuit 10 and fundamental operational blocks FB1-FBn are coupled to a control bus 14. Inter-adjacent-block data buses 16 are arranged between adjacent fundamental operational blocks FB (generically indicating FB1-FBn), although FIG. 1 representatively shows only inter-adjacent-block data bus 16 arranged between adjacent fundamental operational blocks FB1 and FB2.

Fundamental operational blocks FB1-FBn are arranged in parallel, and perform the same or different arithmetic or logic operations in parallel within the operational function module. FIG. 1 representatively shows a construction of fundamental operational block FB1.

Fundamental operational block FB1 includes a main computational circuit 20 including a memory cell array and an arithmetic and logic unit, a microprogram storage memory 23 for storing an execution program in a microcode form, a controller 21 for controlling an internal operation of fundamental operational block FB1, a register group 22 used as an address pointer and others and a fuse circuit 24 for implementing a fuse program, e.g., for repairing a defective portion in main computational circuit 20.

Controller 21 receives control from host CPU 2 according to a control instruction supplied via system bus 5 and input/output circuit 10, and controls fundamental operational blocks FB1-FBn. These fundamental operational blocks FB1-FBn each include microprogram storage memory 23, and controller 21 stores the execution programs in microprogram storage memory 23 so that the contents of processing to be executed in each of fundamental operational blocks FB1-FBn can be changed.

By using inter-adjacent-block data buses 16 for data transfer between fundamental operational blocks FB1-FBn, fast data transfer can be implemented between the fundamental operational blocks without occupying global data bus 12. Also, the data transfer can be performed between fundamental operational blocks while the data transfer is being performed to another fundamental operational block via global data bus 12.

Centralized control unit 15 includes a control CPU 25 (i.e., CPU 25 for control), an instruction memory 26 for storing an instruction to be executed by control CPU 25, a register group 27 including a working register of control CPU 25 or a register for storing a pointer and a microprogram library storage memory 28 storing a library of microprograms. Centralized control unit 15 receives control from host CPU 2 via control bus 14, and controls the processing operations of fundamental operational blocks FB1-FBn via control bus 14.

Microprogram library storage memory 28 stores microprograms obtained by encoding various sequence processings as libraries. Centralized control unit 15 selects a required microprogram to change the microprograms stored in microprogram storage memories 23 of fundamental operational blocks FB1-FBn. Thereby, changes in contents of processing can be flexibly handled.

When fundamental operational blocks FB1-FBn include a defective portion, fuse circuit 24 is utilized to perform redundant replacement for repairing the defective portion, to improve a yield.

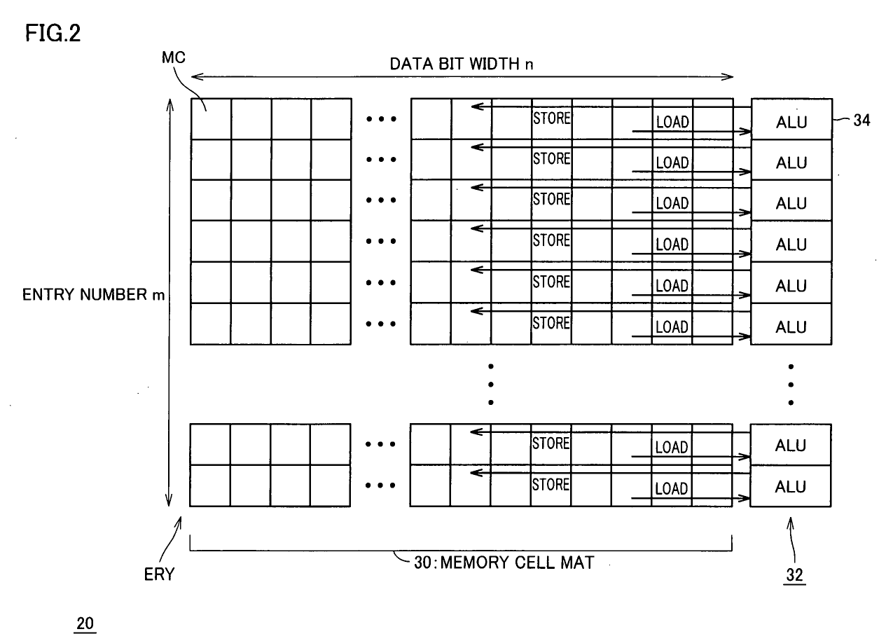

FIG. 2 schematically shows a construction of a main portion of main computational circuit 20 included in each of fundamental operational blocks FB1-FBn shown in FIG. 1. Referring to FIG. 2, main computational circuit 20 includes a memory cell mat 30 having memory cells MC arranged in rows and columns, and an operational processing unit (arithmetic and logic unit ALU) group 32 arranged at one end of memory cell mat 30.

In memory cell mat 30, memory cells MC are arranged in rows and columns and are divided into m entries ERY. Each entry ERY has a bit width of n bits, and is formed of the memory cells arranged in one column along a bit line.

Operational processing unit group 32 includes arithmetic and logic units (ALUs) 34 arranged corresponding to entries ERY, respectively. Arithmetic and logic unit 34 can execute an arithmetic and logic operation such as addition, AND, EXOR and NOT.

An operational processing is executed by loading and storing data between entry ERY and a corresponding arithmetic and logic unit 34.

Each entry ERY stores data to be operational-processed, and arithmetic and logic unit (ALU) 34 executes the operational or calculation processing in a bit serial manner (in which data words are successively processed on a bit-by-bit basis). Therefore, operational processing unit group 32 performs operational processing on the data in the bit serial and entry parallel fashion. The entry parallel fashion represents a fashion in which a plurality of entries are processed in parallel.

Arithmetic and logic unit 34 executes the arithmetic or logic processing in a bit serial fashion. Thus, even when the bit width of the data subject to operational processing varies depending on the application, the number of operation cycles is merely changed depending on the bit width of the data word, and the contents of processing are not changed so that even the processing of data having different word configurations can be easily dealt with.

Also, operational processing unit group 32 can concurrently process the data of the plurality of entries ERY, and operational processing can be collectively effected on a large quantity of data by increasing the number of entries. By way of example, the entry number m is 1024, and the bit width n of one entry ERY is 512 bits.

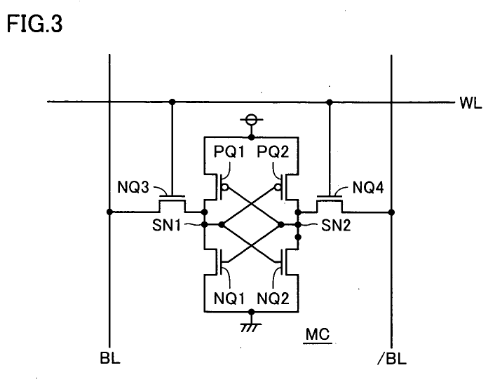

FIG. 3 shows an example of a structure of memory cell MC shown in FIG. 2. In FIG. 3, memory cell MC includes a P channel MOS transistor (insulated gate field effect transistor) PQ1 that is connected between a power supply node and a storage node SN1, and has a gate connected to a storage node SN2, a P channel MOS transistor PQ2 that is connected between the power supply node and storage node SN2, and has a gate connected to storage node SN1, an N channel MOS transistor NQ1 that is connected between storage node SN1 and a ground node, and has a gate connected to storage node SN2, an N channel MOS transistor NQ2 that is connected between storage node SN2 and the ground node, and has a gate connected to storage node SN1, and N channel MOS transistors NQ3 and NQ4 that connect storage nodes SN1 and SN2 to bit lines BL and /BL, respectively, in response to a potential on a word line WL.

Memory cell MC shown in FIG. 3 is a SRAM (Static Random Access Memory) cell, and can implement fast access for transferring data. Periodic refresh of data is not necessary, and control of the operational processing of data can be simplified 1.

Bit lines BL and /BL are arranged in a direction of extension of entry ERY shown in FIG. 2, and word lines WL are arranged perpendicularly to entry ERY.

For performing an arithmetic or logic (operational) operation in main computational circuit 20 shown in FIG. 2, each entry ERY stores the operation target data. Then, bits at a certain location of the stored data are read in parallel from all entries ERY, and are transferred or loaded to corresponding arithmetic and logic units 34, respectively. By driving word line WL in FIG. 3 to the selected state, the data of memory cells MC connected to the selected word line is read onto corresponding bit lines BL and /BL, and the read data is transferred to corresponding arithmetic and logic units 34.

For performing a binary operation (operation of data of two terms), a similar transfer operation is effected on the bit of another data word in each entry ERY, and then each arithmetic and logic unit 34 performs two-input calculation operation. Arithmetic and logic unit 34 rewrites or stores the result of this operational processing in a predetermined region of corresponding entry ERY.

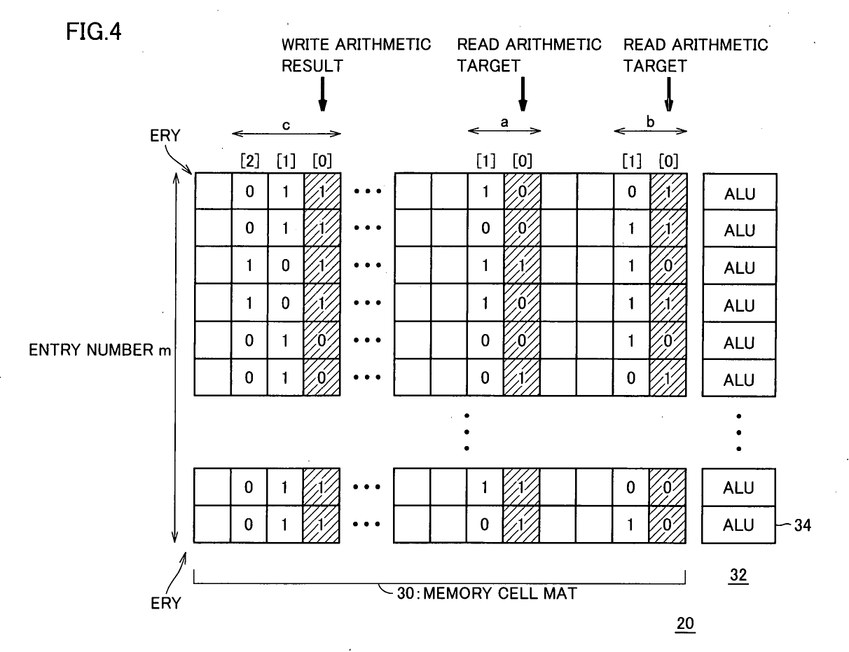

FIG. 4 illustrates by way of example an arithmetic operation in main computational circuit 20 shown in FIG. 2. Referring to FIG. 2, data words a and b each having a width of 2 bits are added together to produce a data word c. Entry ERY stores both data words a and b forming a set of the arithmetic target.

In FIG. 4, arithmetic and logic unit 34 corresponding to entry ERY in the first column performs addition of (10B+01B), and arithmetic and logic unit 34 corresponding to entry ERY in the second column performs addition of (00B+11B), where “B” represents a binary number. The arithmetic and logic unit corresponding to the entry in the third column performs addition of (11B+10B). Data words a and b stored in each of the other entries are added in a similar manner.

The arithmetic operation is successively effected in the bit serial fashion on the bits in ascending digit order. First, entry ERY transfers a lower bit a[0] in data word a to corresponding arithmetic and logic unit 34. Then, a lower bit b[0] in data word b is transferred to corresponding arithmetic and logic unit 34. Each arithmetic and logic unit (ALU) 34 performs addition of two bits of received data. The result (a[0]+b[0]) of this addition is written and stored at a location of a lower bit c[0] of data word c. In the entry, e.g., of the first column, “1” is written at the position of c[0].

This addition processing is then effected on upper bits a[1] and b[1], and an arithmetic result of (a[1]+b[1]) is written at a position of bit c[1].

The addition may produces a carry, and in such case, a carry is written at a position of bit c[2]. In this manner, addition of data words a and b is completed in all entries ERY, and the operation results are written as data c in respective entries ERY. In the construction of 1024 entries, addition of 1024 sets of data can be executed in parallel.

With an assumption that the transfer of data bits between memory cell mat 30 and arithmetic and logic unit 34 requires one machine cycle, and arithmetic and logic unit 34 requires the operation cycle of one machine cycle, four machine cycles are required for addition of two-bit data and storage of a result of the addition. However, following advantageous features are achieved by the construction in which memory cell mat 30 is divided into the plurality of entries ERY, each entry ERY stores the set of operation target data and corresponding arithmetic and logic unit 34 performs an operational processing in the bit serial fashion. Although the operational processing of each data set requires relatively many machine cycles, fast data processing can be achieved by increasing the parallel degree of the calculation when an extremely large quantity of data is to be processed. The operational processing is performed in the bit serial fashion, and the bit width of the data to be processed is not fixed. Therefore, the foregoing construction can be easily adapted to applications having various data configurations.

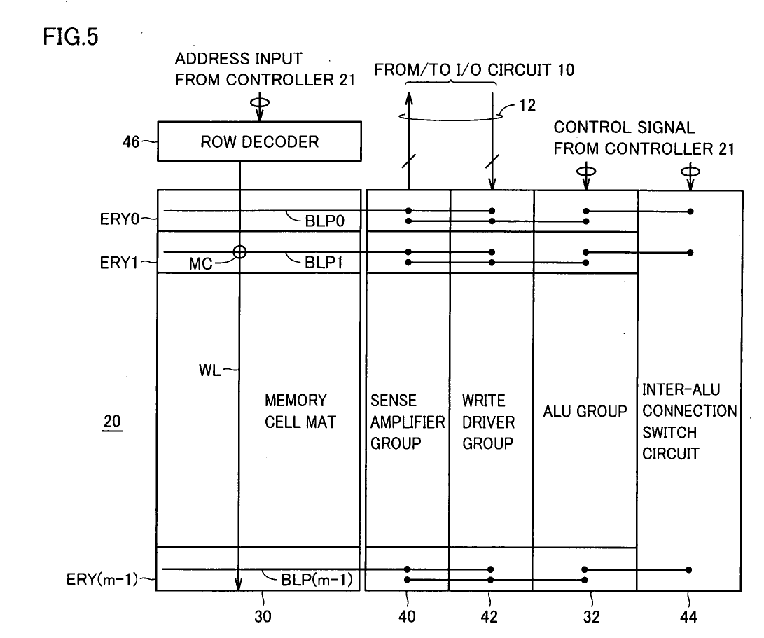

FIG. 5 specifically shows a construction of main computational circuit 20. In memory cell mat 30, word lines WL are arranged corresponding to the respective rows of memory cells MC, and bit line pairs BLP are arranged corresponding to the respective columns of memory cells MC. Memory cells MC are arranged corresponding to the crossings of word lines WL and bit line pairs BLP, and are connected to corresponding word lines WL and bit line pairs BLP, respectively.

Entries ERY are provided corresponding to the bit line pairs BLP, respectively. In FIG. 5, memory cell mat 30 includes entries ERY0-ERY(m-1) provided corresponding to bit line pairs BLP0-BLP(m-1), respectively. Bit line pair BLP is utilized as data transfer lines between corresponding entry ERY and corresponding arithmetic and logic unit 34.

A row decoder 46 is provided for word lines WL in memory cell mat 30. Row decoder 46 drives a word line WL connected to the memory cells storing the data bits to be subject to an operational processing, to the selected state according to an address signal provided from controller 21 shown in FIG. 1. Word line WL is connected to the memory cells at the same location in entries ERY0-ERY(m-1), and row decoder 46 selects the data bits at the same location in the entries ERY.

In operational processing unit group (ALU group) 32, arithmetic and logic units 34 are arranged corresponding to bit line pairs BLP0-BLP(m-1), respectively, although not shown clearly in FIG. 5. A sense amplifier group 40 and a write driver group 42 for loading or storing data are arranged between operational processing group 32 and memory cell mat 30.

Sense amplifier group 40 includes sense amplifiers provided corresponding to bit line pairs BLP, respectively. The sense amplifiers amplify the data read onto corresponding bit line pairs BLP, and transmit the read data to corresponding arithmetic and logic units 34 in operational processing unit group 32, respectively.

Likewise, write driver group 42 includes write drivers arranged corresponding to bit line pairs BLP, respectively. The write drivers amplify the data provided from corresponding arithmetic and logic units 34 for transference to corresponding bit line pairs BLP, respectively.

Global data bus 12 is arranged for transferring data between input/output circuit 10 shown in FIG. 1 and these sense amplifier group 40 and write driver group 42. In the construction shown in FIG. 5, global data bus 12 includes separate bus lines connected to sense amplifier group 40 and to write driver group 42. However, the common data bus line may be connected to these sense amplifier group 40 and write driver group 42. Also, an interface unit for data input/output may be interposed for connecting global data bus 12 to sense amplifier group 40 and write driver group 42.

Further, an inter-ALU connection switch circuit 44 is arranged for operational processing unit group 32. This switch circuit 44 sets interconnection paths between arithmetic and logic units 34 according to a control signal provided from controller 21 shown in FIG. 1. Thus, the data transfer can be performed not only between the arithmetic and logic unit units adjacent to each other but also between the arithmetic and logic units physically remote from each other, similarly to a barrel shifter or the like. This inter-ALU connection switch circuit 44 can be implemented, e.g., by a cross bar switch using a FPGA (Field Programmable Gate Array) or the like.

The operation timing and the contents of the operational processing of each arithmetic and logic unit 34 in operational processing unit group 32 are determined by control signals provided from controller 21 shown in FIG. 1.

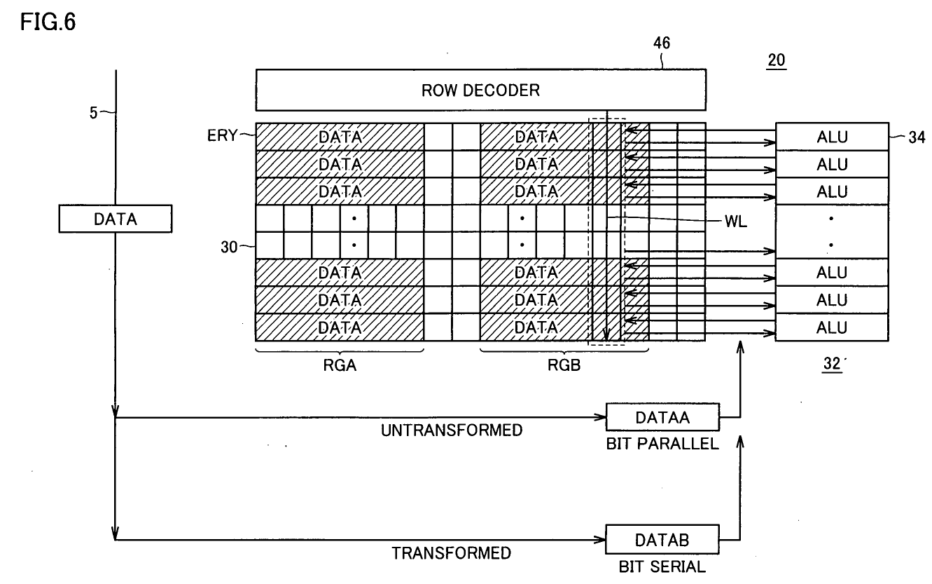

FIG. 6 schematically illustrates storage of data DATA in memory cell mat 30 of main computational circuit 20 as well as an arrangement of external data. In memory cell mat 30, each entry ERY stores a set of data DATA to be processed. FIG. 6 illustrates by way of example a state in which memory cell mat 30 stores the data to be operational-processed in two regions RGA and RGB.

In an operational processing by arithmetic and logic unit group 32, each data bit of entry ERY is transferred to arithmetic and logic unit (ALU) 34. In the operational processing, therefore, row decoder 46 selects word line WL prior to the data transfer. Word line WL is connected to the memory cells in the respective entries ERY of memory cell mat 30, and the data to be operated is transferred in the bit serial fashion to and from arithmetic and logic units 34.

Data DATA transferred onto system bus 5 is a data word at one address (CPU address), and the bits of data DATA are transferred in parallel on system bus 5.

Therefore, in the case where data DATA transferred on system bus 5 is stored in memory cell mat 30 as untransformed bit-parallel data DATAA, the bits of data DATA are dispersed into different entries, respectively, and cannot be stored in one entry ERY. Therefore, it is required that data DATA transferred on system bus 5 is transformed to bit-serial data DATAB by changing its bit arrangement order, and is stored in memory mat 30 by selecting different word lines for the respective bits. When data DATA is, e.g., 16-bit data, and is stored in the bit serial fashion, data transfer to and from the main computational circuit cannot be performed fast, which impairs the advantageous feature, i.e., fast processing by parallel operational processing.

Accordingly, it is necessary to employ a data arrangement transforming circuit which transforms an arrangement of data DATA transferred on system bus 5 into a data word parallel and bit serial form for performing simultaneous writing or reading of data with a plurality of entries. The instant invention provides a construction for data arrangement transformation for performing fast and efficient data transfer between the external system bus or the like and the memory cell mat. Various embodiments of the present invention will now be described.

### First Embodiment

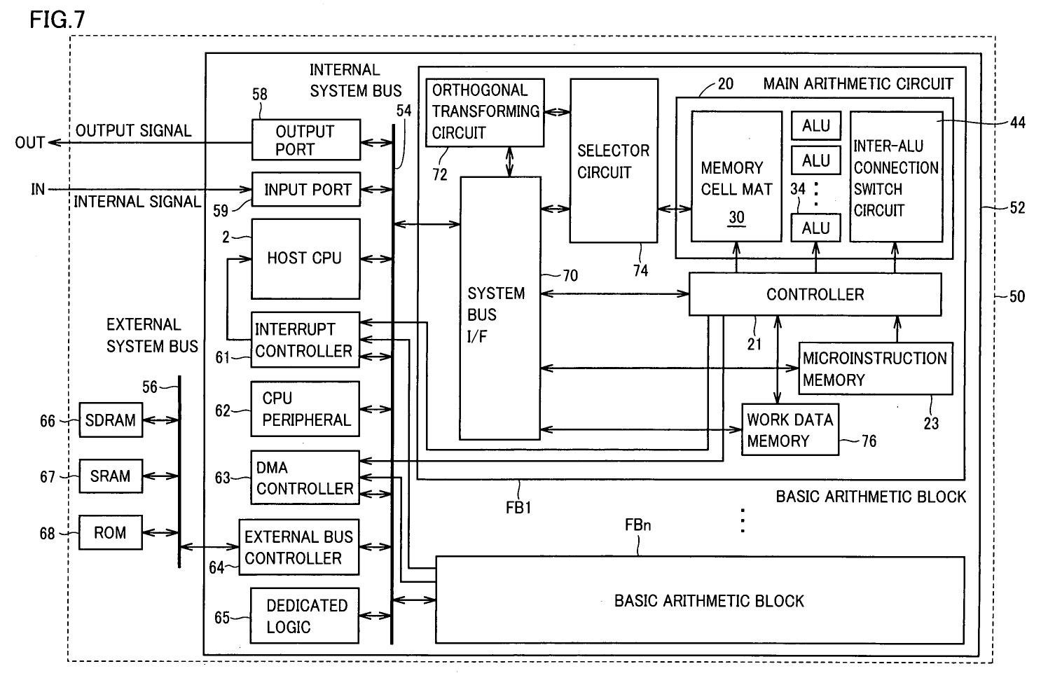

FIG. 7 schematically shows a whole construction of a signal processing system which uses a semiconductor signal processing device according to a first embodiment of the invention. In FIG. 7, signal processing system 50 includes a system LSI 52, which implements an operational processing function of executing various kinds of processing, and external memories connected to system LSI 52 via an external system bus 56.

The external memory includes a large capacity memory 66, a fast memory 67 and a Read Only Memory (RAM) 68 storing fixed information such as instructions used in system startup. Large capacity memory 66 is formed of, e.g., a clock Synchronous Dynamic Random Access Memory (SDRAM), and fast memory 67 is formed of, e.g., a Static Random Access Memory (SRAM).

System LSI 52 has, e.g., a SOC (System On Chip) structure, and includes fundamental operational blocks FB1-FBn coupled in parallel to an internal system bus 54, host CPU 2 controlling processing operations of these fundamental operational blocks FB1-FBn, an input port 59 for transforming an input signal IN externally applied to system 50 into data for internal processing and an output port 58 which receives output data from internal system bus 54, and produces an output signal OUT to be externally applied. These input and output ports 59 and 58 are each formed of, e.g., an IP (Intellectual Property) block which is registered in a library, and implements functions necessary for input and output of data/signal.

System LSI 52 further includes an interrupt controller 61 which receives an interrupt signal from fundamental operational blocks FB1-FBn, and signals host CPU 2 of the interruption, a CPU periphery 62 for performing control operations required for various kinds of processing of host CPU 2, a DMA controller 63 for transferring data to the external memories according to a transfer request supplied from fundamental operational blocks FB1-FBn, an external bus controller 64 for controlling access to the memories 66-68 connected to external system bus 56 according to an instruction received from host CPU 2 or DMA controller 63 and a dedicated logic 65 for assisting data processing of host CPU 2.

CPU periphery 62 has functions required for the programming and debugging in host CPU 2, and specifically has functions of a timer, a serial I/O and others. Dedicated logic 65 is formed of, e.g., an IP block, and implements necessary processing functions by using existing function blocks. These function blocks 58, 59 and 61-65 and host CPU 2 are coupled in parallel to internal system bus 54. DMA controller 63 corresponds to DMA circuit 4 shown in FIG. 1.

DMA controller 63 transfers data to the external memories 66-68 according to the DMA request signal received from fundamental operational blocks FB1-FBn.

Fundamental operational blocks FB1-FBn have the same construction as already described, and FIG. 7 representatively shows the construction of fundamental operational block FB1.

Fundamental operational block FB1 includes main computational circuit 20, microinstruction memory 23, controller 21, a work data memory 76 for storing intermediate processing data or work data of controller 21 and a system bus interface (I/F) 70 for transferring data/signal between fundamental operational block FB1 and internal system bus 54.

Input/output circuit 10 shown in FIG. 1 corresponds to system bus interface (I/F) 70 arranged corresponding to each fundamental operational block.

As already described with reference to FIG. 1, main computational circuit 20 includes memory cell mat 30, arithmetic and logic unit 34 and inter-ALU connection switch circuit 44. FIG. 7 does not show the register group which is arranged in fundamental operational block FB1 and is shown in FIG. 1. However, this register group is arranged inside controller 21, and necessary data is stored in each register of the register group.

Via system bus I/F 70, host CPU 2 or DMA controller 63 can access memory cell mat 30, a control register inside controller 21, microinstruction memory (microprogram storage memory) 23 and work data memory 76.

Different address regions (CPU address regions) are allocated to fundamental operational blocks FB1-FBn, respectively. Likewise, different addresses (CPU addresses) are allocated to memory cell mat 30, the control register in controller 21, microinstruction memory 23 and work data memory 76 in each of fundamental operational blocks FB1-FBn, respectively. According to each allocated address region, host CPU 2 and DMA controller 63 identify fundamental operational block FB (FB1-FBn) to be accessed, and makes the access to the fundamental operational block of interest.

Fundamental operational block FB1 further includes an orthogonal transforming circuit 72 for transforming a data arrangement with respect to system bus I/F 70 and a selector circuit 74 for selecting one of orthogonal transforming circuit 72 and system bus I/F 70, and coupling the selected one to main computational circuit 20.

Orthogonal transforming circuit 72 transforms the data, which is transferred from system bus I/F 70 in the bit parallel and word serial fashion, into the word parallel and bit serial fashion, and writes the bits after transformation in parallel at the same position of the data words in the respective entries of memory cell mat 30 in main computational circuit 20 via selector circuit 74. Orthogonal transforming circuit 72 performs orthogonal transformation on the data train, which is transferred in word parallel and bit serial form from memory cell mat 30 of main computational circuit 20. Thus, integrity in data transfer is maintained between system bus 54 and memory cell mat 30.

The orthogonal transformation described above represents the transformation between the bit serial and word parallel data and the bit parallel and word serial data.

Selector circuit 74 may be configured to select work data from controller 21, and transfer it to main computational circuit 20. In this case, memory cell mat 30 can be utilized as a working data storage region, and work data memory 76 is not required. If the orthogonal transformation of the operation target data is not necessary, selector circuit 74 couples system bus I/F 70 to main computational circuit 20.

In fundamental operational blocks FB1-FBn, the functions corresponding to input/output circuit 10 shown in 1 are arranged in a distributed fashion. Thus, execution and non-execution of the orthogonal transformation of data can be determined on a fundamental operational block basis, i.e., in each fundamental operational block independently of the others, and the data arrangement can be flexibly set according to contents of processing of each fundamental operational block.

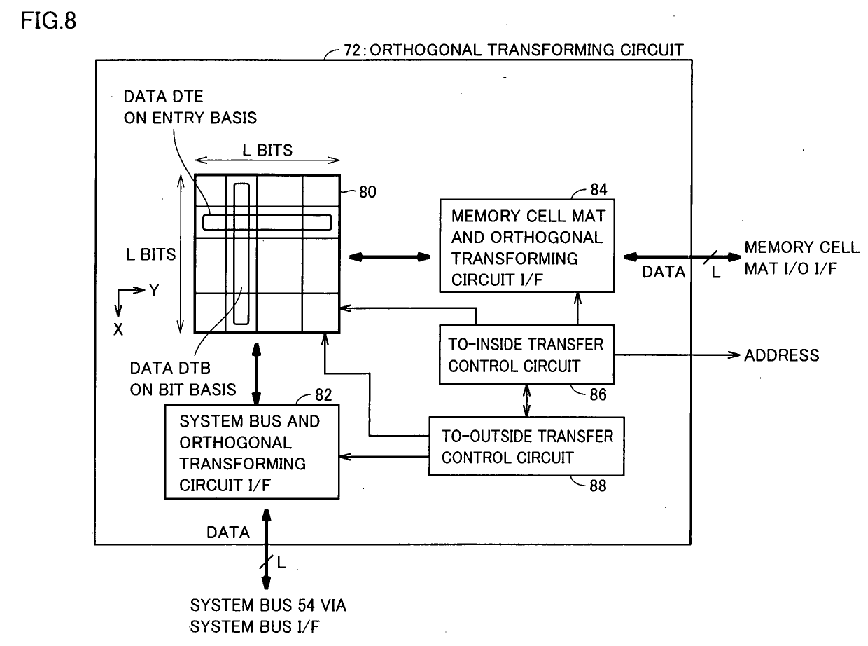

FIG. 8 schematically shows a construction of orthogonal transforming circuit 72 shown in FIG. 7. In FIG. 8, orthogonal transforming circuit 72 includes an orthogonal memory 80 having storage elements arranged in L rows and L columns, a system bus and orthogonal transforming circuit interface (I/F) 82 for providing interface between orthogonal memory 80 and system bus I/F 70, a memory cell mat and orthogonal transforming circuit I/F 84 for providing interface with an I/O interface unit (I/F) arranged for memory cell mat 30, a to-outside transfer control circuit 88 for controlling the data transfer between the system bus and orthogonal memory 80, and a to-inside transfer control circuit 86 for controlling the data transfer between the memory cell mat input/output I/F and orthogonal memory 80. Data is transfer L bits at a time between orthogonal transforming circuit 72 and system bus 54. Data is transfer L bits at a time between orthogonal transforming circuit 72 and the memory cell mat. The transfer data bit width L may be equal to the bit width of the data word transferred through internal system bus 54. Alternatively, the system bus I/F may change the bit width, and multiple word data may be transferred in parallel between system bus I/F 54 and orthogonal transforming circuit 72.

In the operation of transferring data between the memory cell mat and orthogonal transforming circuit 72, to-inside transfer control circuit 86 produces the address for orthogonal memory 80 and the address for the memory cell mat, and controls the buffering operation in the memory cell mat and orthogonal transforming circuit I/F 84. When to-inside transfer control circuit 86 operates to perform the data transfer to or from the memory cell mat, to-inside transfer control circuit 86 controls the operation of to-outside transfer control circuit 88, to wait the data transfer with system bus 54. In the operation of transferring data to the memory cell mat, to-inside transfer control circuit 86 calculates the address based on the entry position information and bit position information of orthogonal memory 80, and transfers the calculated address to the main computational circuit.

In the operation of transferring data to or from system bus 54, to-outside transfer control circuit 88 performs the control to produce the address successively in an X direction, and to perform data access (data writing or reading) to orthogonal memory 80 successively in the X direction. In the operation of transferring data to or from the memory cell mat, to-inside transfer control circuit 86 performs the control to produce the address in a Y direction, and to make data access to orthogonal memory 80 successively in the Y direction.

Orthogonal memory 80 is a two-port memory, transfers data DTE to and from system bus and orthogonal transforming circuit I/F 82 on an entry-by-entry basis and transfers data DTB to and from the memory cell mat and orthogonal transforming circuit I/F 84 multiple bits (belonging to multiple entries) at a time.

In orthogonal memory 80, data DTE aligned in the Y direction is the data on the external address (CPU address) base. In the memory cell mat, this data DTE is also the data on the entry base, and is stored in the same entry. When viewed from the external address, therefore, the bits aligned in the X direction are transferred in the data transfer operation with the memory cell mat, and therefore the data is transferred in the word parallel and bit serial fashion. The data DTB on the bit base represents the data, formed of the bits at the same positions in the plurality of entries of the memory cell mat of the main computational circuit, and thus represents the data on the address base in the memory cell mat of the main computational circuit.

In orthogonal memory 80, a port for data transfer with the system bus is separated from a port for data transfer with the bus inside the memory, and thus the X-direction data and the Y-direction data can be transferred by rearranging the data. For transferring the multi-bit data (multi-bit data on the entry base) from the system bus to the memory cell mat, the data is transferred subject to changing into the multi-bit data on the bit base. In orthogonal memory 80, the arrangement of data is transformed between the word parallel and bit serial form and the word serial and bit parallel form. This transforming processing is defined as the orthogonal transformation as already described.

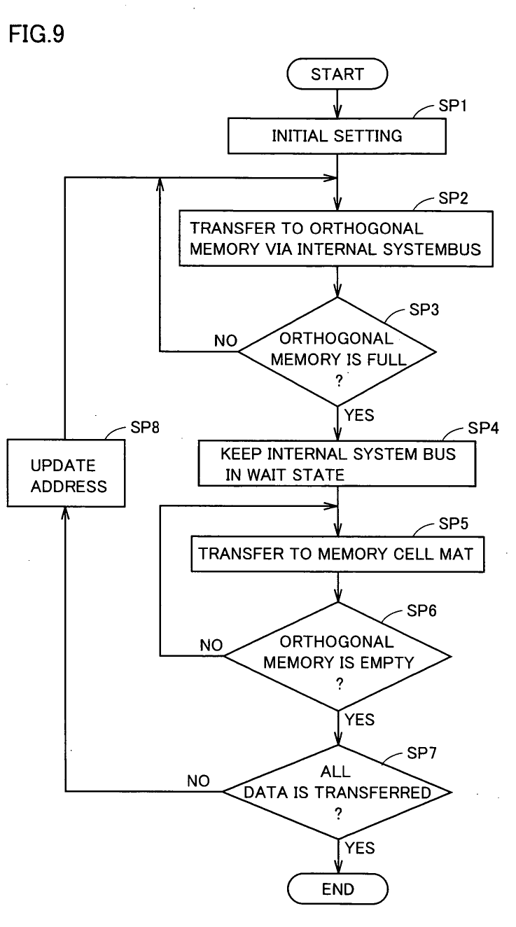

FIG. 9 is a flowchart representing an operation performed when data is transferred to the memory cell mat from orthogonal transforming circuit 72 shown in FIG. 8. The operation of orthogonal transforming circuit 72 will now be described with reference to FIGS. 1, 8 and 9. In the data transfer operation, the data of the same bit width as the data on system bus 54 is transferred from the orthogonal transforming circuit to the memory cell mat of the main computational circuit. Thus, the orthogonal transformation of the data is performed, but the transformation relating to the bit width of the data is not performed. In the transfer operation flow represented in FIG. 9, therefore, bit width L is equal to the bit width of the data on system bus 54.

The starting bit position (word line address) and entry position (bit line address) of the writing target in the memory cell mat of the main computational circuit are set in respective registers (not shown in the figure) of to-inside transfer control circuit 86. Also, to-inside transfer control circuit 86 is set into the data reading mode, and to-outside transfer control circuit 88 is set to the data writing mode. The address for orthogonal memory 80 is set to the initial address. By the series of these operations, the initialization of orthogonal transforming circuit 72 is completed (step SP1).

Then, the transfer data is written from the system bus I/F via system bus and orthogonal transforming circuit I/F 82 into orthogonal memory 80 under the control of to-outside transfer control circuit 88. The data written into orthogonal memory 80 is stored as multi-bit data DTE aligned in the Y direction, on the entry-by-entry basis in orthogonal memory 80 in the order starting from the starting row in the X direction. In response to each writing of the data into orthogonal memory 80, to-outside transfer control circuit 88 counts the writing operations, and updates the address of orthogonal memory 80 (step SP2).

The data writing is performed until orthogonal memory 80 becomes full, i.e., until the number of times of data writing from system bus 54 into orthogonal memory 80 reaches the transfer data bit width L for the memory cell mat of the main computational circuit (step SP3).

When data is written L times into orthogonal memory 80 from system bus 54 via the system bus and orthogonal transforming circuit I/F 82, the data is transferred from orthogonal memory 80 to the memory cell mat of the main computational circuit. Therefore, to-inside transfer control circuit 86 asserts the wait control signal for system bus 54, and sets to-outside transfer control circuit 88 to hold the subsequent data writing in a standby state (step SP4). To-outside transfer control circuit 88 counts the operations of writing the data into orthogonal memory 80, and thereby monitors the storage state of orthogonal memory 80 to determine whether it is in a full state or not. To-outside transfer control circuit 88 signals to-inside transfer control circuit 86 of the result of this monitoring so that to-inside transfer control circuit 86 grasps the state of storage of orthogonal memory 80. By asserting the wait control signal from to-inside transfer control circuit 86, to-outside transfer control circuit 88 sets the system bus and orthogonal transforming circuit I/F 82 to the wait state, and thereby the system bus I/F is set into the wait state.

By holding the to-outside transfer control circuit 88 in the wait state, the to-inside transfer control circuit 86 activates the memory cell mat and orthogonal transforming circuit I/F 84, and the data is read from the addresses starting at the leading address in the Y-direction of orthogonal memory 80 under the control of to-inside transfer control circuit 86, and are transferred to the memory cell mat of the main computational circuit via memory cell mat and orthogonal transforming circuit I/F 84 (step SP5).

Each time the data is transferred to the memory cell mat of the main computational circuit, it is determined whether all the storage data are transferred from orthogonal memory 80 (step SP6). Specifically, to-inside transfer control circuit 86 counts the operations of reading and transferring the data from orthogonal memory 80, and monitors the count for determining whether it reaches L or not. Until the count reaches L, the operation continues to transfer the data for each L bits from orthogonal memory 80 to the memory cell mat and orthogonal transforming circuit I/F 84.

In step SP6, when it is determined that all the data are transferred from orthogonal memory 80, then it is determined whether all the data to be processed is transferred or not (step SP7). When the data to be processed still remains, the address for orthogonal memory 8 is updated to an initial value for storing the data in orthogonal memory 80 again, the number of times of data transfer is initialized (step SP8) and the processing operation starts at step SP2 again.

When the processing operation returns from step SP8 to step SP2, the address updating process is performed to add L to the address representing the entry position in the memory cell mat so that to-inside transfer control circuit 86 updates the leading entry position in the memory cell mat for the data to be stored in orthogonal memory 80.

When the entry position information exceeds the number of entries in the memory cell mat of the main computational circuit, it is necessary to select a next word line in the memory cell mat and to write the data in the next word line position. This entry position information is set to zero, and the word line address (bit position information) is incremented by one for selecting the next word line in the memory cell mat.

To-inside transfer control circuit 86 releases the to-outside transfer control circuit 88 from the wait state with respect to system bus 54, and to-outside transfer control circuit 88 restarts writing of the data from system bus 54 into orthogonal memory 80.

The operations from step SP2 to step SP8 are repeated until all the data to be processed is transferred.

When it is determined in step SP7, according to deasserting of the transfer request supplied from system bus I/F, that all the data are transferred, the data transfer ends. The series of these processing operations can transfer the data, which is externally transferred in the word serial fashion, to the memory cell mat after transformation into the data of the bit serial and word parallel form.

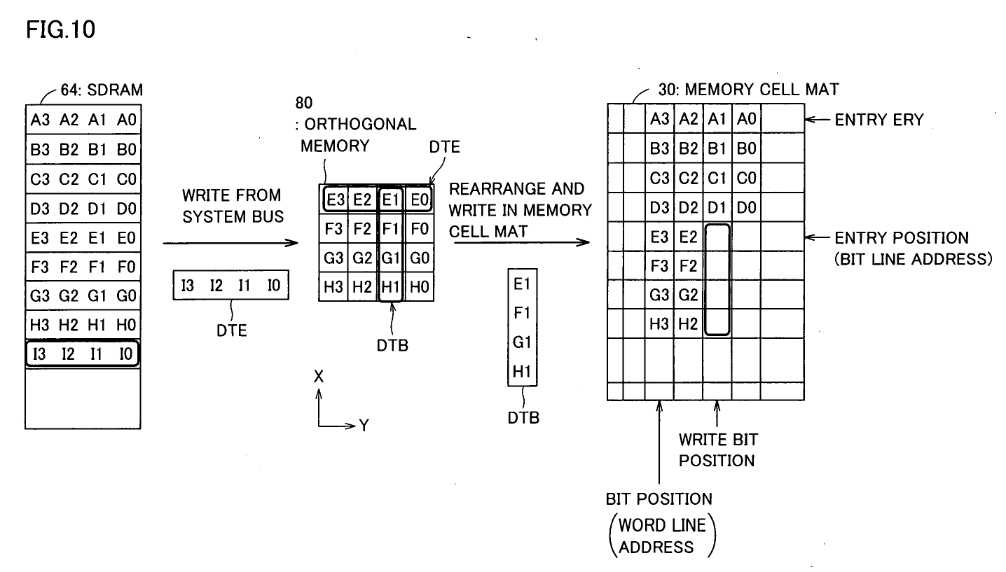

FIG. 10 schematically illustrates the data transfer from large capacity memory (SDRAM) 64 shown in FIG. 8 to memory cell mat 30. FIG. 10 illustrates, by way of example, the data transfer in the case where the bit width L of data with respect to the memory cell mat is 4 bits.

In FIG. 10, SDRAM 64 stores four-bit data A (bits A3-A0)-I (bits I3-I0). Four-bit data DTE (data I: bits I3-I0) is transferred from SDRAM 64 via internal system bus 54 to orthogonal memory 80, and is stored therein. Data DTE provided from SDRAM 64 is the data which is stored in the same entry of the memory cell mat, and thus is the entry base data. When this data DTE is stored in orthogonal memory 80, the data bits are aligned in the Y direction. FIG. 10 illustrates by way of example a state of storage of data E-H.

In the operation of transferring the data from orthogonal memory 80 to memory cell mat 30, the bits of data DTB aligned in the X direction of orthogonal memory 80 are read in parallel. Data DTB, which is formed of data bits E1, F1, D1 and H1 on the address base of the memory cell mat, is stored in the position of memory cell mat 30 indicated by the entry position information and write bit position information. This bit position information is used as the word line address of memory cell mat 30, and the entry position information is used as the bit address of memory cell mat 30. These bit position information and entry position information are stored in the registers of the to-inside transfer control circuit 86 shown in FIG. 8, and is transferred as the address information. The write bit position information indicating the actual write position of data in memory cell mat 30 is produced based on the number of times of access to memory cell mat 30 as well as the entry position information and the bit position information.

The data bits are concurrently stored in the Y direction by using orthogonal memory 80, and then the aligned data bits are read in the X direction so that data DTE, which is read on the entry basis in the word serial and bit parallel fashion from SDRAM 64, can be transformed into data DTB on the address base of the word parallel and bit serial form, and transformed data DTB can be stored in memory cell mat 30.

In the operation of reading and transferring the data from memory cell mat 30 to internal system bus 54, the data is transferred in the opposite direction, but the operation of orthogonal memory 80 is the same as that in the operation of writing data into memory cell mat 30. To-inside transfer control circuit 86 successively stores the data, which is read from the memory cell mat, at the positions of orthogonal memory 80 starting at the leading position in the Y direction. Then, to-outside transfer control circuit 88 successively reads the data at the positions, which start at the leading position in the X direction, of orthogonal memory 80, and thus, the data, which is read from memory cell mat 30 in the word parallel and bit serial fashion, can be transformed into the data in the word serial and bit parallel form.

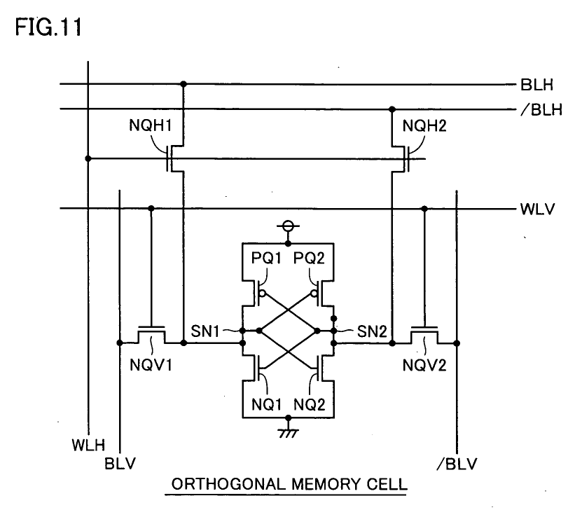

FIG. 11 shows an example of a structure of the memory cell included in orthogonal memory 80. The memory cell included in orthogonal memory 80 is formed of a dual port SRAM cell. In FIG. 11, the orthogonal memory cell includes cross-coupled load P channel MOS transistors PQ1 and PQ2 as well as cross-coupled drive N channel MOS transistors NQ1 and NQ2 for data storage. The orthogonal memory cell includes an inverter latch as a data storage element similarly to a normal SRAM cell, and this inverter latch (flip-flop element) stores complementary data on storage nodes SN1 and SN2.

The orthogonal memory cell further includes N channel MOS transistors NQH1 and NQH2 which couple storage nodes SN1 and SN2 to bit lines BLH and /BLH in response to the signal potential on a word line WLH, respectively, as well as N channel MOS transistors NQV1 and NQV2 which couple storage nodes SN1 and SN2 to bit lines BLV and /BLV in response to the signal potential on a word line WLV, respectively. Word lines WLH and WLV are arranged perpendicularly to each other, and bit lines BLH and /BLH are arranged perpendicularly to bit lines BLV and /BLV.

Word line WLH and bit lines BLH and /BLH form a first port (transistors NQH1 and NQH2), and word line WLV and bit lines BLV and /BLV form a second port (transistors NQV1 and NQV2). The first and second ports are coupled to different orthogonal memory interfaces, respectively. For example, the first port (word line WLH and bit lines BLH and /BLH) is utilized as a port to the memory data bus, and is selected under the control of the to-inside transfer control circuit. The second port (word line WLV and bit lines BLV and /BLV) is utilized as a port for interface to internal system bus 54, and is selected by the to-outside transfer control circuit 88. Thereby, the data access can be performed by performing the transformation between the rows and columns in the orthogonal memory.

By utilizing orthogonal transforming circuit 72 as described above, the data of a multi-bit width can be transposed when transferring the data between the system bus and the memory cell mat, and it is possible to reduce the number of times of access, which is required for data transfer to the memory cell mat, to the memory cell mat. Thereby, the time required for the data transfer can be reduced, and fast processing can be achieved.

Orthogonal memory 80 formed of the SRAM cells can reduce a layout area as compared with a construction using D flip-flops or the like as circuit elements, and can perform the orthogonal transformation of a large quantity of data with a small occupation area.

In orthogonal memory 80 described above, the bit width of the transferred data is equal to the bit width of the data on the system bus. Therefore, it may possibly become difficult to transfer the data in real time when a large quantity of data such as image data are to be stored. Now, description will now be given on the construction which efficiently transfers a large quantity of data between the main computational circuit and the memory cell mat.

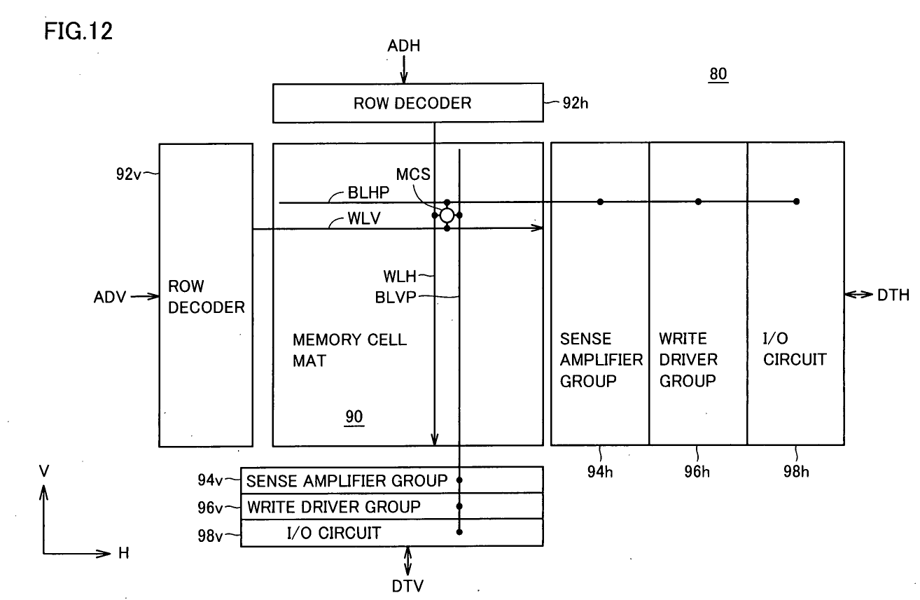

FIG. 12 schematically shows a specific construction of orthogonal memory 80 according to the invention. In FIG. 12, orthogonal memory 80 includes a memory cell mat 90 having SRAM cells MCS arranged in rows and columns. In memory cell mat 90, horizontal bit line pairs BLHP and vertical word lines WLV are arranged corresponding to SMRAM cells MCS aligned in the horizontal direction H. Horizontal word lines WLH and vertical bit line pairs BLVP are arranged corresponding to SRAM cells MCS aligned in the vertical direction V shown in FIG. 12. Word line WLV is arranged corresponding to bit line pair BLVP, and word line WLH is arranged corresponding to bit line pair BLVP. SRAM cell MCS is connected to word lines WLV and WLH as well as bit line pairs BLHP and BLVP. SRAM cell MCS has a construction shown in FIG. 11.

Orthogonal memory 80 further includes a row decoder 92v for selecting vertical word line WLV in memory cell mat 90 according to a vertical word address ADV, a sense amplifier group 94v for sensing and amplifying the memory cell data read onto vertical bit line pair BLVP, a write driver group 96v for writing data into the memory cell on vertical bit line pair BLVP and an input/output circuit 98v for performing input/output of vertical data DTV.

Orthogonal memory 80 further includes a row decoder 92h for decoding a horizontal word address ADH to select a horizontal word line WLH in memory cell mat 90, a sense amplifier group 94h for sensing and amplifying the memory cell data read onto horizontal bit line pair BLHP, a write driver group 96h for writing the data into the memory cell on horizontal bit line pair BLHP and an input/output circuit 98h for performing input/output of the data with sense amplifier group 94h or write driver group 96h.

One of input/output circuits 98v and 98h transfers the data with the system bus, and the other transfers the data with the memory cell mat. In the following description, it is assumed that the data on the entry basis is successively stored in the vertical direction V, and the data on the bit basis is successively stored in the horizontal direction. In the vertical direction V, there are arranged m word lines WLV equal in number to the entries of the memory cell mat in the main computational circuit. In the horizontal direction H, there are arranged word lines WLH equal in number to or more than the bits of the data stored in one entry. For transferring the bits in all the entries with the memory cell mat, input/output circuit 98h performs the input/output of data of m bits. After the data is stored for all the entries, orthogonal memory 80 transfers the data to the memory cell mat of the main computational circuit.

Therefore, when row decoders 92v and 92h select word lines WLV and WLH, all the transfer data bits are selected so that a column decoder for performing the column selection is not provided.

Addresses ADV and ADH applied to row decoders 92v and 92h are produced by counting the operations of accessing orthogonal memory 80, and are produced by to-inside transfer control circuit 86 or to-outside transfer control circuit 88 shown in FIG. 8.

Word line WLH and bit line pair BLHP form one data access port (i.e., port to the main computational circuit), and word line WLV and bit line pair BLVP form the other data access port (i.e., port to the system bus I/F).

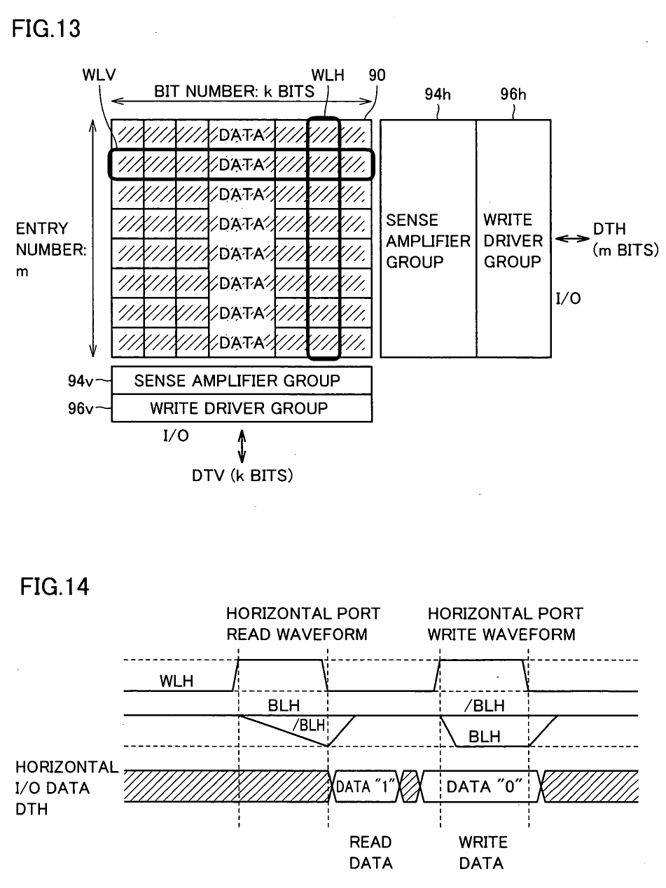

FIG. 13 illustrates an example of the array of data stored in orthogonal memory 80 shown in FIG. 12. Memory cell mat 90 has m entries, and each entry has a width of k bits. Vertical word line WLV selects one entry, and data DTV of k bits is input and output via sense amplifier group 94v and write driver group 96v to and from a selected entry. Data DTV is transferred with the system bus via the system bus I/F.

Horizontal word line WLH is arranged perpendicularly to the entry, and sense amplifier group 94h and write driver group 96h inputs and outputs data DTH of m bits from and to the memory cells selected by horizontal word line WLH, respectively. Data DTH of m-bits in width is stored in parallel in the memory cell mat of the main computational circuit.

FIG. 14 is a signal waveform diagram representing the access operation for horizontal data DTH in orthogonal memory 80 shown in FIG. 13. Referring to FIG. 14, description will now be given on the operation of the orthogonal memory performed when the data is transferred with the main computational circuit.

For transferring data DTH from the orthogonal memory to the main computational circuit, row decoder 92h shown in FIG. 12 selects horizontal word line WLH. When word line WLH is driven to the selected state, memory cell data are read onto horizontal bit lines BLH and /BLH. The memory cell data thus read are sensed and amplified by sense amplifier group 94h, and subsequently data DTH of m bits is output via the input/output circuit. FIG. 14 illustrates the data of one bit, and specifically illustrates an example in which bit line BLH is at the H-level, and data “1” is read.

After reading the data, bit lines BLH and /BLH return to the initial state.

In the operation of writing data DTH in memory cell mat 90, write driver group 96h operates according to data DTH, and transfers the write data to bit lines BLH and /BLH in parallel with the selection of word line WLH. In the example shown in FIG. 14, the write data is “0”, and bit lines /BLH and BLH are driven to the H and L levels, respectively.

After the data writing is completed, word line WLH is driven to the unselected state, and bit lines /BLH and BLH return to the initial state. The operations of writing and reading the data as represented in FIG. 14 are substantially the same as the operations for data accessing of a standard SRAM.

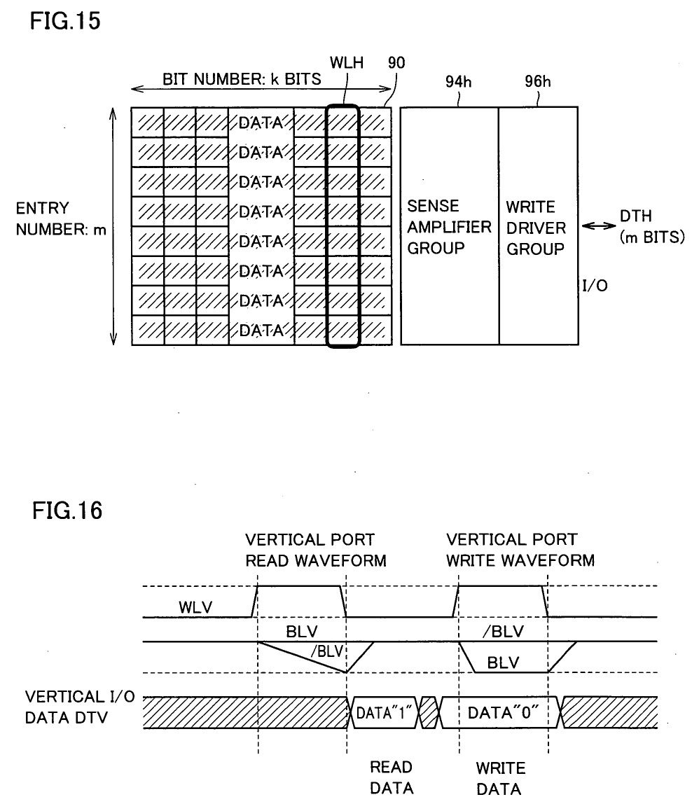

FIG. 15 schematically illustrates a flow of the data during input/output operations of data DTH. As illustrated in FIG. 15, word line WLH is selected, and data at the same bit positions of data DATA stored in the m entries are read in parallel to perform input/output of data DTH of m bits. Therefore, when the entries of the memory cell mat of the main computational circuit are m in number, the data at the same locations in the entries can be transferred in one data transfer cycle. In this case, even if the number m of entries is 1024, the internal data bus for the memory cell mat is an on-chip internal interconnection, and can be arranged sufficiently without restriction by pin terminals and others.

FIG. 16 is a timing diagram representing the data input/output operations for data transfer with the system bus of the orthogonal memory illustrated in FIG. 13. Referring to FIG. 16, description will now be given on the operations of inputting and outputting vertical data DTV to and from the orthogonal memory illustrated in FIG. 13.

For inputting or outputting data DTV, row decoder 92v shown in FIG. 12 drives word line WLV to the selected state as shown in FIG. 16. Accordingly, k bits in one entry are read in parallel onto corresponding bit lines BLV and /BLV. FIG. 16 also shows a read waveform for one-bit data, and shows an example in which bit lines BLV and /BLV are driven to the H and L levels; respectively, and data “1” is read.

For writing the data, word line WLV is driven to the selected state, and the write data is transmitted onto bit lines BLV and /BLV via write driver group 96v. FIG. 16 shows an example in which data “0” is written, and bit line BLV is driven to the L level.

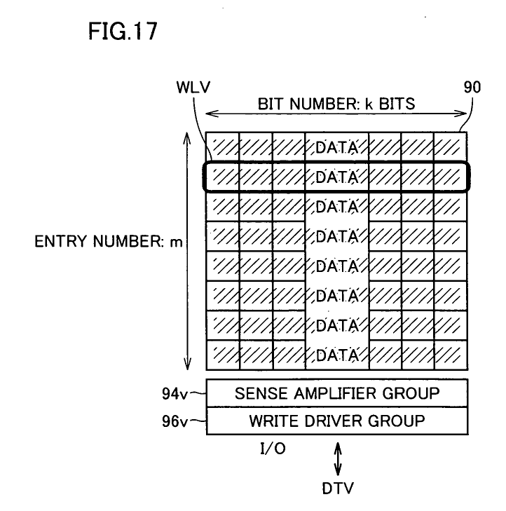

FIG. 17 schematically illustrates a flow of data in the operation of writing data DTV. As illustrated in FIG. 17, word line WLV is selected in memory cell mat 90, and the input/output of data DTV is performed via sense amplifier group 94v and write driver group 96v. In this case, data DTV is k-bit data, and the data of k bits is transferred to the system bus.

In this orthogonal memory, operations similar to those in the normal SRAM are effected on each of the ports inputting or outputting data DTV and DTH. Even when the number m of entries is large, memory cell mat 90 having a relatively small layout area can be employed to store and transform the operation target data.

When operational data of a different bit width is employed, a tolerable maximum value of the bit width is set at the data bit width of k bits, and the selection range of horizontal word line WLH (i.e., variable range of horizontal address ADH) is set according to the operation data bit width, so that the operation data of a different bit width can be easily accommodated for.

As described above, the orthogonal memory employs the SRAM cells, and the two-port memories are utilized. Thus, the transformation of the data arrangement between the operational processing circuit performing an operational processing on the data in the bit serial and entry parallel fashion and the bus (system bus and others) outside the computational circuit, can be easily implemented by the compact circuit construction.

The bit width of the data transfer between the orthogonal transforming circuit and the main computational circuit can be set equal to the number of entries in the memory cell mat of the main computational circuit. Thereby, fast data transfer can be achieved.

### Second Embodiment

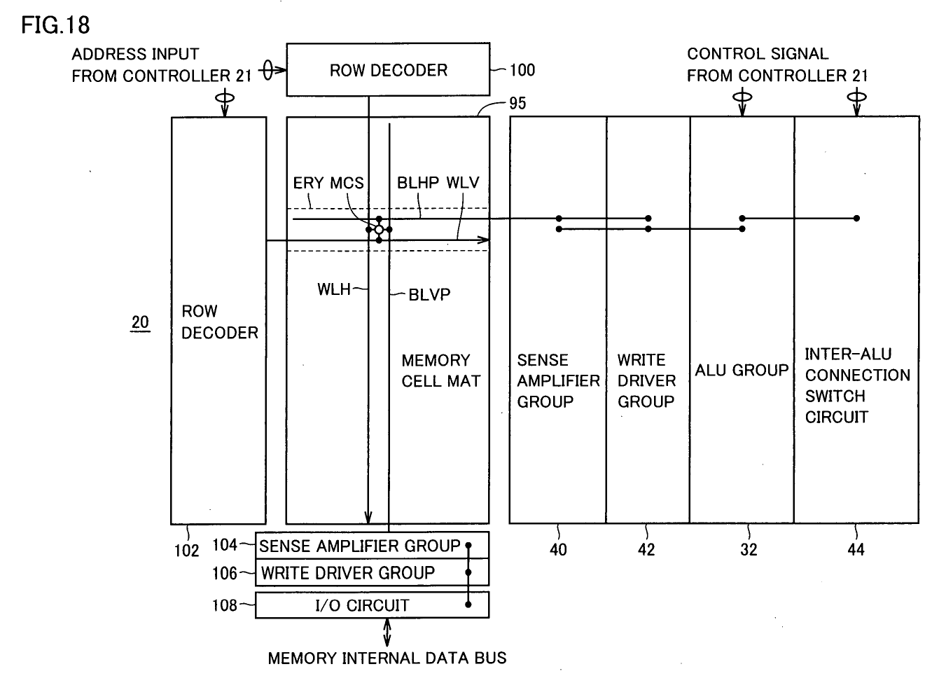

FIG. 18 schematically shows a construction of main computational circuit 20 according to a second embodiment of the invention. Main computational circuit 20 has a memory cell mat 95 in which two-port SRAM cells MCS are arranged in rows and columns. Two-port SRAM cell MCS has substantially the same structure as that shown in FIG. 11.

In memory cell mat 95, word lines WLV are arranged perpendicular to word lines WLH. Bit line pairs BLHP are arranged parallel and corresponding to word lines WLV, and bit line pairs BLVP are arranged parallel and corresponding to word lines WLH.

A row decoder 100 selects word line WLH, and a row decoder 102 selects word line WLV. Word line WLV and bit line pair BLHP are connected to SRAM cells MCS included in a common entry ERY.

The sense amplifier in sense amplifier group 40 and the write driver in write driver group 42 are arranged corresponding to entry ERY, and the arithmetic and logic unit (ALU) in operational processing unit group (ALU group) 32 is also arranged corresponding to entry ERY. Inter-ALU connection switch circuit 44 is arranged neighboring to operational processing unit group 32. The constructions of sense amplifier group 40, write driver group 42, operational processing unit group 32 and inter-ALU connection switch circuit 44 are the same as those in the main computational circuit shown in FIG. 5.

Row decoder 100 corresponds to row decoder 46 shown in FIG. 5, and selects word line WLH according to the address signal received from controller 21. Likewise, controller 21 provides the control signals to operational processing unit group (ALU group) 32 and inter-ALU connection switch circuit 44.

Main computational circuit 20 further includes row decoder 102 for selecting word line WLV according to the address signal received from controller 21, a sense amplifier group 104 for reading the memory cell data on bit line pair BLVH, a write driver group 106 for writing the data in the memory cell on bit line pair BLVP and an input/output circuit 108 for performing input/output of data between sense amplifier group 104 and write driver group 106, and the memory internal data bus.

The memory internal data bus, i.e., the data bus inside the memory may be a global data bus shown in FIG. 1, and alternatively may be a data bus connected to the system bus I/F already described. The second embodiment does not employ the orthogonal transforming circuit in the first embodiment. The memory internal data bus transfers the data of the same bit array as the data on the system bus.

For transferring the data between memory cell mat 95 and input/output circuit 108, row decoder 102 selects word line WLV to input or output the data on the entry-by-entry basis. When performing an operational processing using operational processing unit group (ALU group) 32, row decoder 100 selects word line WLH, and selects the bits at the same position in the plurality of entries (i.e., selects data on the bit base), and the operational processing is executed in the entry parallel fashion.

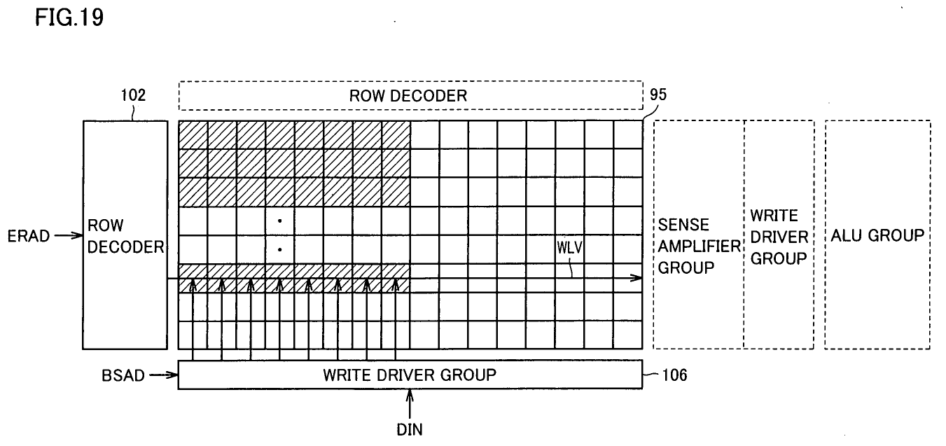

FIG. 19 schematically illustrates a flow of data in the operation of writing the data from main computational circuit 20 to memory cell mat 95 shown in FIG. 18. In FIG. 19, write driver group 106 receives write data DIN which is externally supplied to main computational circuit 20. Row decoder 102 selects word line WLV according to an entry address ERAD. Write driver group 106 selectively activates the write drivers according to a block address BSAD. Write data DIN is written in a region designated by block address BSAD on the selected word line of memory cell mat 95. Entry address ERAD is successively updated to select successively word lines WLV by row decoder 102, and write driver group 106 is selectively activated block (processing target data storage region) by block to write data DIN therein. Accordingly, the data can be stored at the region, which is designated by block address BSAD, in each entry on the region-by-region basis or a block by block basis.

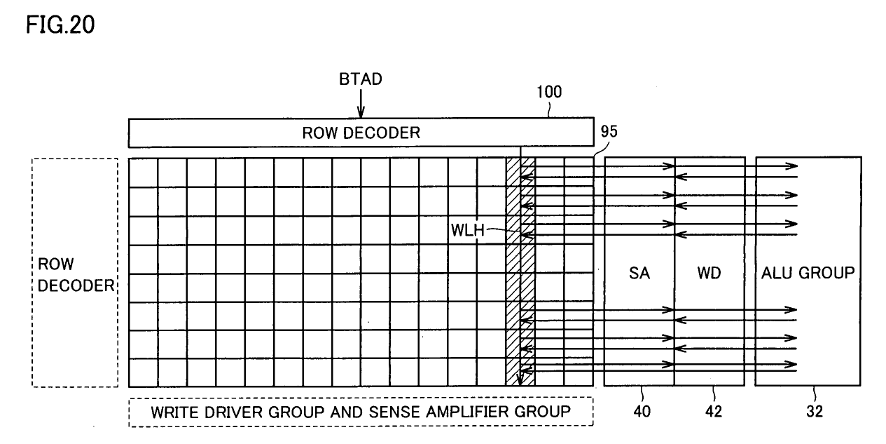

FIG. 20 schematically illustrates a flow of data in an operational processing by main computational circuit 20 shown in FIG. 18. For executing the operational processing, row decoder 100 selects word line WLH according to bit address BTAD to read the bits of the processing target data in serial, and sense amplifier group 40 transfers the respective bits of data to operational processing unit group 32. A result of the operational processing in operational processing unit group 32 is stored on word line WLH selected by row decoder 100 via the write driver (WD) included in write driver group 42.

By successively updating bit address BTAD for row decoder 100 in accordance with each operational processing target data bit, operational processing unit group 32 can execute the operational processing in the bit serial and entry parallel fashion.

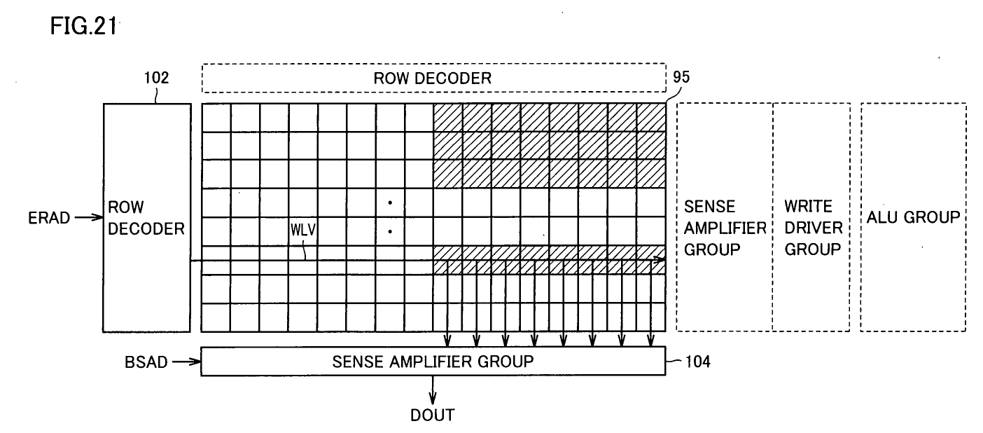

FIG. 21 schematically illustrates a flow of data in the operation of reading the processing result data externally from the main computational circuit. In this case, row decoder 102 selects word line WLV according to entry address ERAD, and sense amplifier group 104 is selectively activated on the block-by-block basis according to the block address BSAD, to amplify the operational processing result data to produce read data DOUT.

When reading this operational processing result data, entry address ERAD is successively updated so that operational processing result data DOUT can be read in word serial and bit parallel.

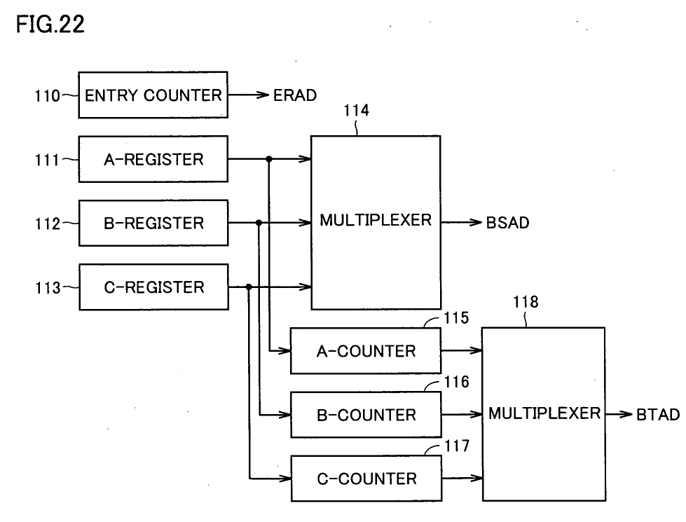

FIG. 22 schematically shows an example of a construction of a portion for generating addresses ERAD, BSAD and BTAD as shown in FIGS. 19-21. In FIG. 22, the address generating unit includes an entry counter 110 for counting the operations of transferring the data externally with the main computational circuit, to produce entry address ERAD, an A-register 111 for storing the block address of processing data A, a B-register 112 for storing the block address of the storage block region of processing data B, a C-register 113 for storing the address of the block region storing operational processing result data C, a multiplexer 114 for selecting the stored values in registers 111-113 to produce block address BSAD, an A-counter 115 having an initial value set according to the stored value in A-register 111 and counting the number of times of selection of processing data A during the operational processing, a B-counter 116 having an initial value set according to the stored value in B-register 112, and incrementing its count when each bit in processing data B is selected, a C-counter 117 having an initial value set according to the stored value in C-register 113, and incrementing the count in response to each storage of the bit of the operational processing result data, and a multiplexer 118 for producing bit address BTAD by selecting the output counts of the counters 115-117.

Entry counter 110 is set to the initial value when performing the input/output of data with memory cell mat 95, and successively produces entry addresses ERAD starting at the leading value of the entry. The block addresses in registers 111-113 are determined in accordance with the data bit width and the contents of the operational processing to be executed. For storing processing target data A and B, multiplexer 114 selects the stored value in register 111 or 112 to produce block address BSAD. For providing operational processing result data C, multiplexer 114 selects the stored value in C-register 113 to produce block address BSAD.

The initial values of counters 115-117 are set to the addresses designating the lowest bit storage locations in corresponding blocks according to the stored values in registers 111-113, respectively. For selecting processing target data A or B, the count of A- or B-counter 15 or 16 is selected to produce bit address BTAD. For storing the operational processing result data, multiplexer 118 selects the count of C-counter 117 to produce bit address BTAD.

Based on the stored value in the address generating unit shown in FIG. 22, controller 21 successively executes the processing according to the instruction stored in the micro-program instruction memory.

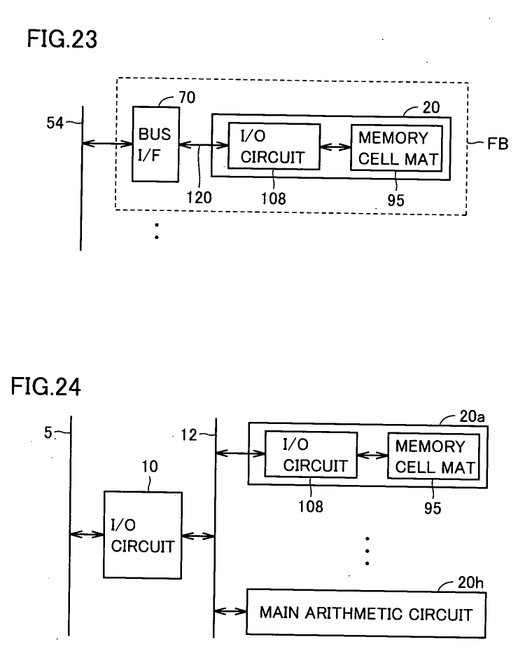

FIG. 23 shows by way of example a system construction according to the second embodiment of the invention. In FIG. 23, internal system bus 54 is connected to fundamental operational blocks FB. Although a plurality of fundamental operational blocks FB are arranged, FIG. 23 representatively shows only one of such fundamental operational blocks.

In fundamental operational block FB, main computational circuit 20 is coupled to system bus 54 via bus interface unit (I/F) 70. Between bus I/F 70 and input/output circuit 108 in main computational circuit 20, memory internal data bus 120 shown in FIG. 18 is arranged. In this case, therefore, bus interface unit (I/F) 70 is placed for each fundamental operational block FB, and the data transfer can be performed in the word serial fashion between system bus 54 and memory cell mat 95 without transforming the data arrangement on memory internal data bus 120.

FIG. 24 shows another example of the system construction according to the second embodiment of the invention. In FIG. 24, main computational circuits 20a-20h are coupled in parallel to global data bus 12. Main computational circuits 20a-20h have the same construction, and FIG. 24 representatively shows the construction of main computational circuit 20a. In main computational circuit 20a, input/output circuit 108 is coupled to global data bus 12, which corresponds to the memory internal data bus shown in FIG. 18. Global data bus 12 is coupled to system bus 5 via input/output circuit 10 (see FIG. 1).

In main computational circuit 20a of the system construction shown in FIG. 24, memory cell mat 95 has a two-port construction, and input/output circuit 10 is not required to transform the data arrangement. In the shown system construction, data can be transferred to and from memory cell mat 95 while performing the data transfer in the word serial fashion between system bus 5 and input/output circuit 108 of main computational circuit 20a.

By employing the two-port construction in memory cell mat 95 of the main computational circuit, the data transfer corresponding to contents of the operational processing can be effected on the main computational circuit, which in turn performs the operational processing in the bit-serial/entry-parallel fashion, in both the operation of external data transfer and the processing operation. In this case, the orthogonal transforming circuit for transforming the data arrangement on the bus is not particularly required, and the layout area of the fundamental operational block can be reduced.

### Third Embodiment

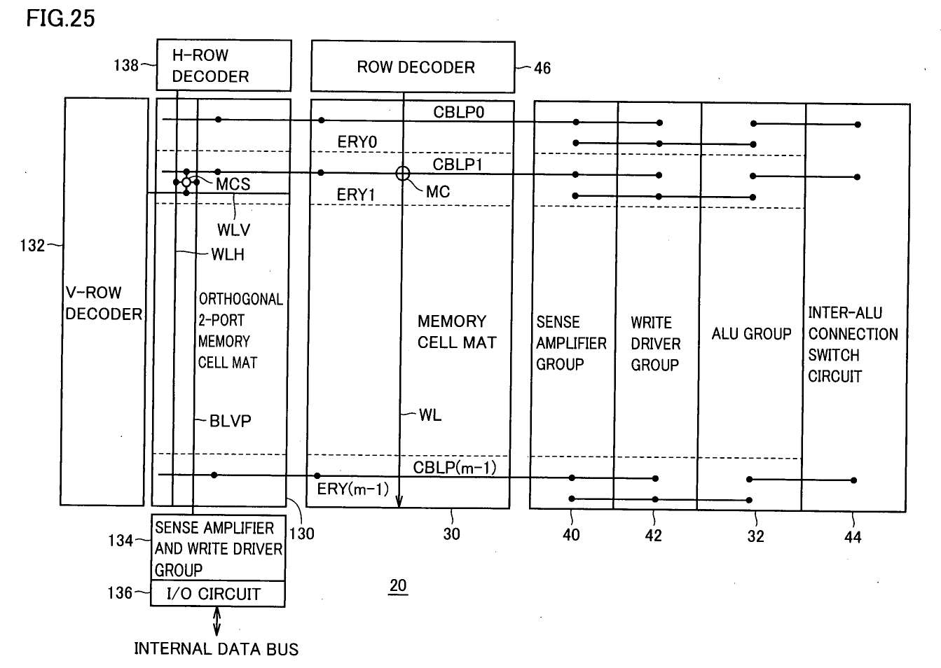

FIG. 25 schematically shows a construction of main computational circuit 20 according to a third embodiment of the invention. In main computational circuit 20 shown in FIG. 25, an orthogonal two-port memory cell mat 130 is arranged adjacent to memory cell mat 30. Memory cell mat 30 includes memory cells of a single port construction in rows and columns. Word lines WL are arranged corresponding to memory cell rows, respectively, and shared bit line pairs CBLP0-CBLP(m-1) each shared by memory cell mats 30 and 130 are arranged corresponding to the memory cell columns, respectively.

In orthogonal two-port memory cell mat 130, bit lines BLVP are arranged perpendicularly to shared bit line pairs CBLP0-CBLP(m-1). Word lines WLV are arranged parallel and corresponding to shared bit line pairs CBLP0-CBLP(m-1), respectively, and word lines WLH are arranged parallel and corresponding to bit line pairs BLVP, respectively. Orthogonal two-port memory cell mat 130 includes two-port memory cells MCS.

For orthogonal two-port memory cell mat 130, there are provided a V-row decoder 132 for selecting word line WLV, a sense amplifier and write driver group 134 for transferring data with the memory cells on word line WLV selected by V-row decoder 132, an input/output circuit 136 for transferring data between sense amplifier and write driver group 134 and the internal data bus, and an H-row decoder 138 for selecting word line WLH.

For operational processing memory cell mat 30 for storing the operational processing data, there are provided sense amplifier group 40, write driver group 42, arithmetic and logic unit group 32 and inter-ALU connection switch circuit 44, as in the foregoing first and second embodiments.

In the construction of main computational circuit 20 shown in FIG. 25, data transfer is performed externally to main computational circuit 20 via orthogonal two-port memory cell mat 30, and the processing data is transferred to memory cell mat 30. Thereafter, the operational processing is performed between memory cell mat 30 and operational processing unit group 32. Orthogonal two-port memory cell mat 130 is used only for externally transferring the data outside main computational circuit 20, and therefore the occupation area thereof can be reduced.

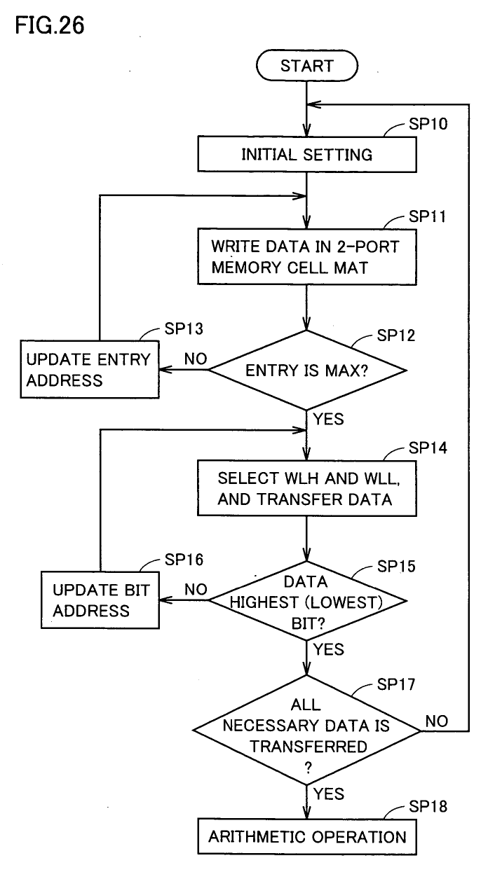

FIG. 26 is a flow chart representing an operation in which the operational processing data are set in memory cell mat 30 of main computational circuit 20 shown in FIG. 25. Referring to FIG. 26, description will now be given on the operation of setting the operational processing data in main computational circuit 20 shown in FIG. 25.

First, a data transfer request is issued to main computational circuit 20, and the controller (21; not shown in FIG. 25) initializes the addresses for V- and H-row decoders 130 and 138 (step SP10).

After this initialization, V-row decoder 132 drives word line WLV to the selected state according to the received entry address. In parallel with this, input/output circuit 136 receives the data applied via the internal data bus, and the data write mode is set. Accordingly, the write driver group in sense amplifier and write driver group 134 is made active to transfer the write data onto bit line pairs BLVP (step SP11).

Then, word line WLV is driven to the unselected state, and then it is determined whether the entry address for the selected word line WLV reaches a final entry number MAX or not (step SP12). Final entry number MAX is the maximum entry number or the minimum entry number. When it is determined that the entry number has not reached the final value in orthogonal two-port memory cell mat 130, the entry address is updated (step SP13). Then, the process returns to step SP11, and the processing as described is repeated until the data writing is performed in the final entry.

When it is determined in step SP12 that the data writing is executed on last entry MAX, the storage of the processing target data in orthogonal two-port memory cell mat 130 is completed, and then the data transfer from orthogonal two-port memory cell mat 130 to memory cell mat 30 is performed. In this data transfer operation, H-row decoder 138 selects word line WLH and, in each of shared bit line pairs CBLP0-CBLP(m-1), the data read from orthogonal two-port memory cell mat 130 is amplified by sense amplifier group 40, is further amplified by write driver group 42 and is transferred onto shared bit line pairs CBLP0-CPLP(m-1). Thereafter, row decoder 46 drives word line WL to the selected state, so that the data transfer from orthogonal two-port memory cell mat 130 to memory cell mat 30 can be executed on the word line basis (bit-base data at a time) (step SP14).

After the data transfer is completed, word lines WL and WLH are driven to the unselected state, and sense amplifier group 40 and write driver group 42 are driven to the inactive state. Thereafter, it is determined whether data of the highest- or lowest-order bit are transferred or not (step SP1). If the successive data transfer started at the lowest order bit, it is determined whether the transferred data is the highest order bit or not. If the successive data transfer started at the highest order bit, it is determined whether the currently transferred data is the lowest order bit or not. FIG. 26 shows the determination processing for both the sequences.

When it is determined that all the bits of the data are not yet transferred, the bit address is updated and applied to row decoder 46 (step SP16), and the operations starting at step SP14 et seq. are repeated again. When it is determined that all the bits of the data stored in orthogonal two-port memory cell mat 130 are transferred, it is then determined whether all the data required for the operational processing is transferred or not (step SP17). When all the required data is not yet transferred, the process returns to step S10 again for setting the next processing target data, and the initialization of the initial addresses of V- and H-row decoders 132 and 138 is performed. Also, the initial address of the data storage region of the next operational processing target is set as the bit address in row decoder 46, and the storage of the next processing target data in orthogonal two-port memory cell mat 130 is repeated.

When it is determined in step SP17 that all the data required for the operational processing is transferred, the loading of data is completed, and the operational processing is executed with operational processing unit group 32 (step SP18).

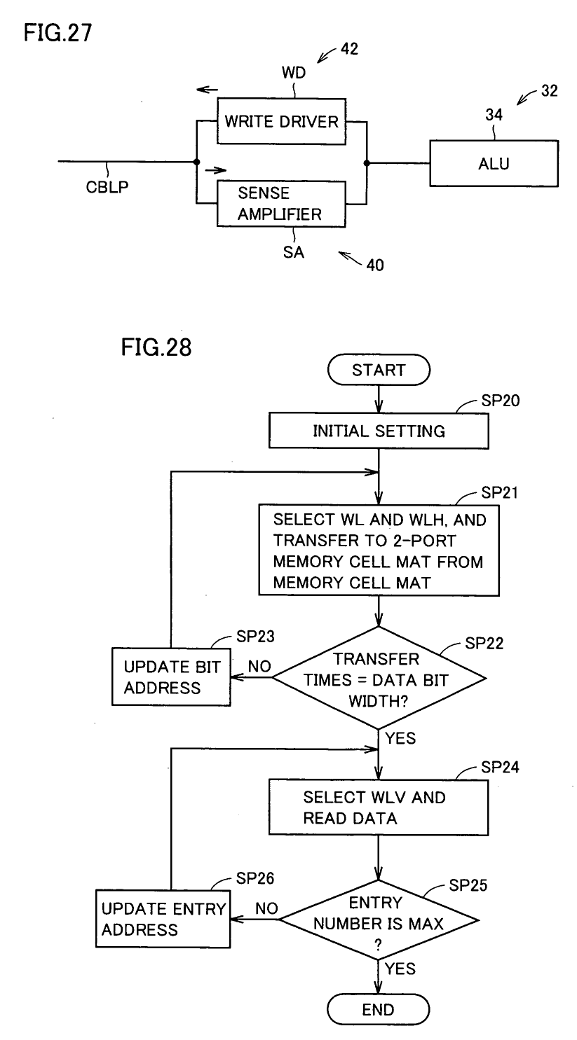

FIG. 27 schematically shows a connection of the shared bit line pair to the sense driver and write driver which are included in sense amplifier group 40 and write driver group 42, respectively. In FIG. 27, a sense amplifier SA and a write driver WD are arranged in parallel between shared bit line pair CBLP and arithmetic and logic unit (ALU) 34. Sense amplifier SA is included in sense amplifier group 40, and write driver WD is included in write driver group 42 shown in FIG. 25. Arithmetic and logic unit (ALU) 34 is included in operational processing unit (ALU group) 32 shown in FIG. 25.

As shown in FIG. 25, sense amplifier SA and write driver WD are arranged for each entry ERY (ERY0-ERY(m-1)) as indicated by solid-filled circles in FIG. 25. Therefore, when the data is transferred between orthogonal two-port memory cell mat 130 and memory cell mat 30, sense amplifier SA amplifies the data on shared bit line pair CBLP, and the data is transferred to shared bit line pair CBLP via write driver WD. Thus, the memory cell data in orthogonal two-port memory cell mat 130 can be written in the memory cells connected to word line WL in memory cell mat 30.

By utilizing sense amplifier group 40 and write driver group 42 for the operational processing as the means for data transfer between the memory cell mats, it is not necessary to provide the transfer circuit dedicated to the data setting, and the circuit layout area can be reduced.

However, a bidirectional data transfer circuit having constructions similar to those of the sense amplifier and write driver on each shared bit line pair CBLP may be arranged between memory cell mats 30 and 130. When transferring the data from memory cell mat 130 to memory cell mat 30, it is not required in the bidirectional data transfer circuit to activate the sense amplifiers, and the current consumption can be reduced (in SRAM cell, nondestructive read of data is performed, and rewriting of data is not necessary, the write driver transfers data from the mat 130 to the mat 30). Word lines WLH and WL are driven to the selected state in parallel, and the cycle time of the data transfer can be reduced.

FIG. 28 is a flowchart representing an operation of transferring the data subject to an operational processing in memory cell mat 30, externally from the main computational circuit via input/output circuit 136. Referring to FIG. 28, description will now be given on the operation of transferring the data after the operational processing.

When the operational processing is completed, initialization is performed for the data transfer after the operational processing (step SP20). In this initialization, the initial bit address of the region for storing the processed data is set in row decoder 46. The addresses of V-row decoders 132 and 138 are set to the initial values.

Then, row decoder 46 selects word line WL in memory cell mat 30, and sense amplifier group 40 and write driver group 42 amplifies the data of the memory cells connected to selected word line WL to cause full swing of shared bit line pairs CBLP0-CBLP(m-1). Then, H-row decoder 138 drives word line WLH to the selected state, and the data transmitted onto shared bit line pairs CBLP0-CBLP(m-1) by write driver group 42 are stored in the respective memory cells (step SP21).

After completion of this transfer operation, i.e., after word lines WL and WLH are driven to the unselected state, it is determined whether the number of times of data transfer from memory cell mat 30 to orthogonal two-port memory cell mat 130 is equal to the bit width of the processed data (step SP22). For this determination operation, the selection operation by row decoder 46 may be counted. Alternatively, controller (21) may merely count the transfer cycles.

When the number of times of transfer does not reach the bit width of the processed data, the bit address is updated (step SP23), and the processing operations starting from step SP21 are repeated. According to this bit address, row decoder 46 drives word line WL corresponding to the next operational processing data bits to the selected state. Also, H-row decoder 138 drives word line WLH corresponding to the next count subsequent to the initial value to the selected state.

In step SP22, when it is determined that the number of times of transfer is equal to the bit width of the data to be processed, data is then read from orthogonal two-port memory cell mat 130 via input/output circuit 136 (step SP24) externally. In this case, V-row decoder 132 selects word line WLV to activate the sense amplifier group in sense amplifier and write driver group 134, and thereby the data subject to the operational processing are read onto the internal data bus via input/output circuit 136.

V-row decoder 132 selects word line WLV for reading the data, and it is determined whether the entry number in orthogonal two-port memory cell mat 130 reaches the final value (MAX) or not (step SP25). When the entry number reaches the final value, the entry address is updated (step SP26), and the processing starting at step SP24 is executed again to drive successively word lines WLV.

In orthogonal two-port memory cell mat 130, when it is determined that the entry storing the processed data reaches the final entry of the final entry number, it is determined that all the processed data are read, and the transfer operation ends.

In this circuit construction shown in FIG. 25, the bit address and the entry address can be set as the respective initial addresses by utilizing the registers shown in FIG. 22.

The internal data bus may be a global data bus, or may be a bus connected to the system bus interfaces (I/F) provided for the respective fundamental operational blocks (see FIGS. 23 and 24).

If the data are transferred from memory cell mat 30 to memory cell mat 130 in the construction having the bidirectional data transfer circuit arranged on each shared bit line pair CBLP between memory cell mats 30 and 130, with the write driver of such bidirectional data transfer circuit being activated, word lines WL and WLH are driven to the selected state in parallel to perform the data transfer via the write driver.

According to the third embodiment of the invention, the orthogonal two-port memory cell array is arranged adjacently to the memory cell mat of the main computational circuit. Thus, only the two-port memory cells of the minimum bit width are required and therefore, increase in area can be suppressed. In addition, it is possible to perform efficient input/output of data between the outside of the main computational circuit and the memory cell mat performing the bit serial and entry parallel operational processing.

### Fourth Embodiment

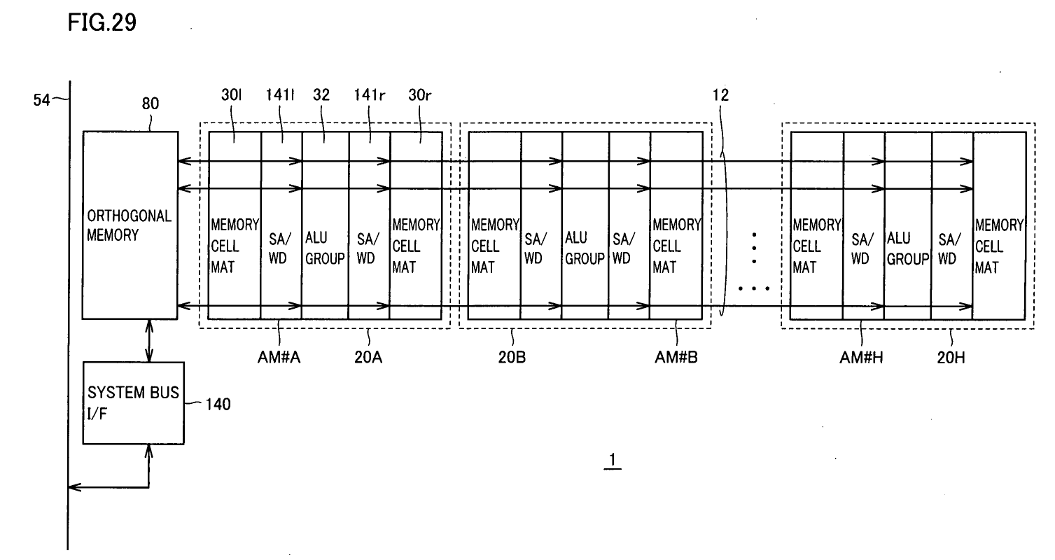

FIG. 29 schematically shows a construction of a main portion of a semiconductor signal processing device (operational function module) according to a fourth embodiment of the invention. Referring to FIG. 29, the semiconductor signal processing device (operational function module) 1 includes main computational circuits 20A-20H arranged in parallel. These main computational circuits 20A-20H include operational array mats AM#A-AM#H for performing an operational processing. These operational array mats AM#A-AM#H have the same constructions, and therefore reference numerals are assigned only to components of operational array mat AM#A, respectively.

Operational array mat AM#A includes memory cell mats 30l and 30r each including memory cells arranged in rows and columns, bit line pairs, word lines, sense amplifier and write driver bands 141l and 141r arranged corresponding to respective memory cell mats 30l and 30r, and operational processing unit group (ALU group) 32 arranged between sense amplifier and write driver bands 141l and 141r. Each of memory cells in memory cell mats 30l and 30r is a single-port memory cell, and a bit line pair is arranged corresponding to each entry.

By arranging operational processing unit group 32 of arithmetic and logic units (ALU) between memory cell mats 30l and 30r, the bit line pairs can be short so that the bit line load can be mitigated.

Sense amplifier and write driver bands 141l and 141r include sense amplifiers SA and write drivers WD arranged corresponding to the bit line pairs in memory cell mats 30l and 30r. The arithmetic and logic units (ALUs), which perform an operational processing such as an arithmetic operation or a logical operation while transferring the data with sense amplifier and write driver bands 141l and 141r, are arranged corresponding to the respective entries (bit line pairs, or sense amplifiers and write drivers).

Global data bus 12 shared by operational array mats AM#A-AM#H is arranged as the internal data bus. Global data bus 12 includes bus lines which are arranged corresponding to the entries of operational array mats AM#A-AM#H, and are coupled to the respective inputs of write drivers and the respective outputs of sense amplifiers in operational array mats AM#A-AM#H.

By arranging global data bus 12 at a layer above operational array mats AM#A-AM#H, the planar layout area required for arranging global data bus 12 can be hidden by the planar layout area of the operational array mat so that the occupation area footprint of the operational function module can be reduced.

Global data bus 12 is coupled to orthogonal memory 80. Orthogonal memory 80 has substantially the same construction as that shown in FIG. 12, and performs the orthogonal transformation (change between rows and columns) of the data array. Orthogonal memory 80 is coupled to system bus 54 via a system bus I/F 140.

Main computational circuits 20A-20H are assigned specific addresses, respectively, and controller (21) perform the control on transference of data between the memory cell mat in the corresponding operational array mat and global data bus 12 according to an applied address.

The data transfer operation between orthogonal memory 80 and operational array mats AM#A-AM#H is substantially the same as that already described with reference to FIGS. 3 and 4. Specifically, for storing a processing target data in operational array mats AM#A-AM#H, the data is successively stored in orthogonal memory 80 via system bus I/F 140. When the data is stored in orthogonal memory 80, orthogonal memory 80 transfers the data successively in a bit serial and word parallel (entry parallel) fashion onto global data bus 12. Under the control of the controller of the main computational circuit, in which address is designated, the data is stored in memory cell mats 30l and 30r in selected operational array mat AM# (one of mats AM#A-AM#H).

By successively switching the addresses specifying main computational circuits 20A-20H, the arithmetic processing target data can be stored in main computational circuits 20A-20H.

For transferring data from operational array mats AM#A-AM#H to system bus 54, the controllers included in main computational circuits 20A-20H issue bus requests to interrupt controller (61) or DMA controller (63) shown in FIG. 7. Together with this bus request information, the controllers of main computational circuits 20A-20H provides the addresses specifying themselves, and the to-inside transfer control circuit of orthogonal memory 80 is made active under the control of the external controller to transfer the data from the main computational circuit to the orthogonal memory. After this transfer of data to the orthogonal memory 80, the to-outside transfer control circuit of orthogonal memory 80 is activated via system bus I/F 140 under the control of the external controller, to successively transfer the data onto system bus 54 via system bus I/F 140.

In this transfer control operation, the control circuit included in system bus I/F 140 may control the bus request and the bus data transfer wait. The main computational circuit is designated under the control of the host CPU, and the data transfer from the designated main computational circuit is performed under the control of the controller in the fundamental operational block which has the control transferred from the host CPU. In this operation, the controller in the system bus I/F activates the to-inside and to-outside transfer control circuits in orthogonal memory 80. Also, the address specifying the main computational circuit is provided from input/output circuit 10 or system bus I/F 140 in the arrangement shown in FIG. 1 via control bus 14 shown in FIG. 1 to controller (21) in the fundamental operational block corresponding to each main computational circuit.

The data transfer operation between orthogonal memory 80 and the selected main computational circuit is substantially the same as that of the third embodiment already described.

According to the fourth embodiment of the invention, as described above, the orthogonal memory for transforming the data arrangement is arranged so as to be shared by a plurality of main computational circuits (fundamental operational blocks), and it is not necessary to arrange the memory circuit for the orthogonal transformation in each of the fundamental operational blocks so that the occupation area of the semiconductor signal processing device can be reduced.

### Fifth Embodiment

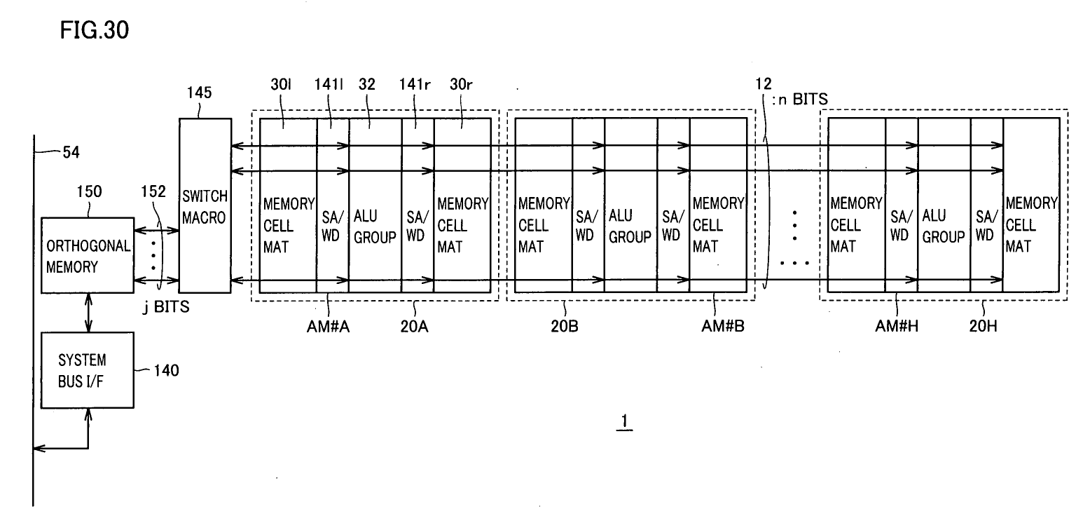

FIG. 30 schematically shows a construction of a semiconductor signal processing device (operational function module) 1 according to a fifth embodiment of the invention. Semiconductor signal processing device (operational function module) 1 shown in FIG. 30 differs in construction from that shown in FIG. 29 in the following points. Global data bus 12 is coupled to a switch macro 145 for changing the bus width, and switch macro 145 is coupled to an orthogonal memory 150 via a bus 152. Orthogonal memory 150 is coupled to system bus 54 via system bus I/F 140.

Other constructions of semiconductor signal processing device 1 shown in FIG. 1 are the same as those of semiconductor signal processing device (operational function module) 1 shown in FIG. 29. The corresponding portions are allotted with the like reference numerals, and description thereof is not repeated.

Orthogonal memory 150 transfers the data with switch macro 145 via bus 152 of a bus width of j bits. The internal construction of orthogonal memory 150 is the same as that of orthogonal memory 80 shown in FIG. 12, except for that the entry number is smaller than that in FIG. 12.

Switch macro 145 changes the bus width to achieve a reduced scale of orthogonal memory 150.

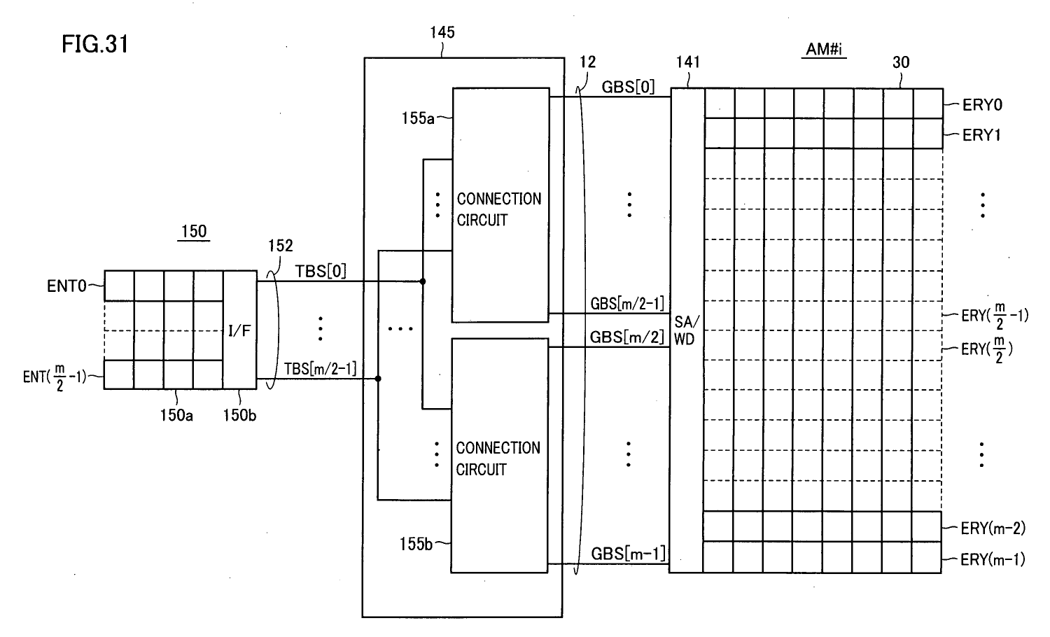

FIG. 31 shows an example of a construction of switch macro 145 shown in FIG. 30. FIG. 31 shows memory cell mat 30 (30r or 30l) and sense amplifier and write driver group 141 (141r or 141l) in operational array mat AM#i. In operational array mat AM#i, memory cell mat 30 includes entries ERY0-ERY(m-1), and bus lines GBS[0]-GBS[m-1] of global data bus 12 are arranged corresponding to the respective entries. These bus lines GBS[0: m-1] of global data bus 12 are coupled to the respective sense amplifiers SA and the respective write drivers WD in sense amplifier and write driver group 141.

Orthogonal memory 150 includes a two-port memory cell mat 150a having two-port memory cells arranged in rows and columns, and an interface (I/F) 150b for transferring data to and from data bus 152. Interface 150b includes sense amplifiers, write drivers and input/output buffers.

Two-port memory cell mat 150a is divided into entries ENT0-ENT(m/2-1). Bus lines TBS[0] -TBS[m/2-1] of data bus 152 are arranged corresponding to entries ENT0-ENT(m/2-1), respectively.

Switch macro 145 includes a connection circuit 155a performing the data transfer between bus lines GBS[0] -GBS[m/2-1] of global data bus 12 and data bus lines TBS[0] -TBS[m/2-1], and also includes a connection circuit 155b performing the data transfer between global data bus lines GBS[m/2]-GBS[m-1] and data bus lines TBS[0]-TBS[m/2-1].

For downloading the data to memory cell mat 30, the following operation is performed. First, the data is successively stored in entries ENT0-ENT(m/2-1) of orthogonal memory 150 from the system bus (not shown). When orthogonal memory 150 attains a full state, the data is transferred via interface (I/F) 150b. In this operation, connection circuit 155a is first activated in switch macro 145 to connect data bus lines TBS[0: m/2-1] to global data bus lines GBS[0: n/2-1]. In this state, the data stored in orthogonal memory 150 are transferred to entries ERY0-ERY(m/2-1) in memory cell mat 30, and are stored in the corresponding memory cell mat. Connection circuit 155b is inactive, and no data is written into entries ERY(m/2)-ERY(m-1).

Then, the next operational processing data are transferred and stored in orthogonal memory 150. In orthogonal memory 150, when the data are stored in entries ENT0-ENT(m/2-1), then, connection circuit 155b is made active, and connection circuit 155a is made inactive. Global data lines GBS[m/2: m-1] are coupled to data bus lines TBS [0: m/2-1]. The data in orthogonal memory 150 are transferred and stored in entries ERY(m/2)-ERY(m-1) of memory cell mat 30.

For transferring data from memory cell mat 30 to orthogonal memory 150, the data transfer is performed in the opposite direction, and connection circuit 155a is activated to store the data of entries ERY0-ERY(m/2-1) of memory cell mat 30 in orthogonal memory 150, followed by the data transfer onto the system bus. When the data transfer from orthogonal memory 150 onto the system bus is completed, connection circuit 155b is then activated to store the data of entries ERY(m/2)-ERY(m-1) of memory cell mat 30, in orthogonal memory 150.

For the data transfer operation, a sense amplifier and write driver group 141 may be configured such that a block select signal activates the sense amplifiers or write drivers arranged corresponding to the connection circuit activated according to the selected entries.

In addition, the following construction may be employed. A row decoder is arranged in a central portion of memory cell mat 30. For data transfer with the orthogonal memory, the block division is performed in memory cell mat 30 by a block select signal to activate the memory cell mat block corresponding to the connection circuit in the active state. For data transfer with the arithmetic and logic units, the block division of memory cell mat 30 is stopped, and the data in all the entries of memory cell mat 30 are selected.

A control signal for activating/deactivating these connection circuits 155a and 155b is produced according to the transfer request under the control of the to-inside transfer control circuit (86) included in the orthogonal transforming circuit shown in FIG. 8.

According to a fifth embodiment of the invention, as described above, the switch macro changing the bus width is arranged between the global data bus shared by the operational array mats and the input/output port of the orthogonal memory. Thus, the scale of the orthogonal memory can be reduced.

### Sixth Embodiment

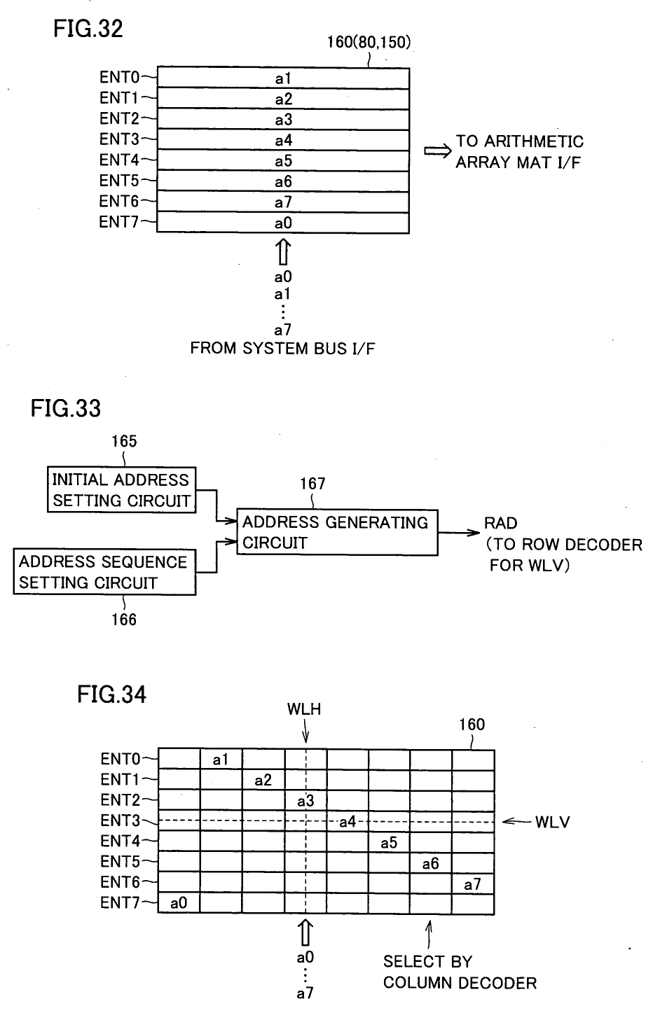

FIG. 32 illustrates an example of an arrangement of storage data in the orthogonal memory according to a sixth embodiment of the invention. In FIG. 32, an orthogonal memory 160 includes eight entries ENT0-ENT7, as an example. Orthogonal memory 160 corresponds to orthogonal memory150 or 80 shown in FIG. 31 or 12. When the data is transferred to orthogonal memory 160 from the system bus I/F, data a0, a1, a7 each of a predetermined bit width are successively transferred in serial. Orthogonal memory 160 stores first data a0 in entry ENT7, and then sequentially stores data a1, a2, . . . a7 in entries NT0, NT1, NT6, respectively.

For transferring the data to an operational array mat, the data are transferred sequentially from entries ENT0-ENT7 in a bit serial and entry parallel fashion, and are stored in the corresponding memory cell mat via the interface unit (the sense amplifier and write driver group) of the operational array mat.

Therefore, the storage positions (entry addresses) of the data to be processed in the operational array mat are different from the transfer order (CPU addresses) of the data transferred from the system bus, and the address of the external operational data can be transformed and stored in the operational array mat.

FIG. 33 shows an example of a construction of the portion for generating the addresses in the sixth embodiment of the invention. Referring to FIG. 33, the address generating unit includes an initial address setting circuit 165 for setting an initial address, an address sequence setting circuit 166 for designating a selection sequence of the addresses, and an address generating circuit 167 for producing an address RAD according to the initial address received from initial address setting circuit 165 and the address sequence information received from address sequence setting circuit 166. Address RAD generated by address generating circuit 167 is supplied to the row decoder for selecting a vertical word line WLV in orthogonal memory 160.

Initial address setting circuit 165 is formed of, e.g., a register circuit, and stores the address designating the entry for storing the leading data.

Address sequence setting circuit 166 produces information relating to (+1)-addition, (+2)-addition and an address updating sequence from the final end position to a central position and others. This address sequence setting circuit 166 may successively set the update address sequence according to the micro-program instruction.

Address generating circuit 167 performs an addition or subtraction of the address value on the initial address set by initial address setting circuit 165, according to the update address sequence information designated by address sequence setting circuit 166, and produces entry address RAD.

The address generating unit shown in FIG. 33 may be arranged inside the orthogonal memory. Alternatively, such a construction may be employed that the controller in the fundamental operational block requesting the data transfer calculates the address, and provides the calculated address to the orthogonal memory.

As described above, the address sequence is changed in the orthogonal memory to change the mapping between the data transferred from the system bus and the data stored in the operational array mat. Owing to such construction, the data sequence changing operation can be easily implemented by using the operational array mat and the orthogonal memory.

[Modification 1]

FIG. 34 shows an example of the data storage state in the orthogonal memory according to a modification of the sixth embodiment of the invention. Orthogonal memory 160 shown in FIG. 34 includes eight entries ENT0-ENT7, as an example. Each of entries ENT0-ENT7 has a bit width sufficient for storage of eight pieces of data. Vertical word lines WLV are arranged corresponding to entries ENT0-ENT7, respectively, and horizontal word lines WLH perpendicular to entries ENT0-ENT7 are arranged corresponding to the data bits, respectively.

When the system bus sequentially transfers data a0, a1, a7, orthogonal memory 160 successively stores data rows a0-a7 in entries ENT7 and ENT0-ENT6. In this operation, the data storage regions in each of entries ENT0-ENT7 are sequentially shifted in the entry extension direction.

Therefore, according to the operation, likewise the mapping of data a0-a7 transferred from the system bus can be changed in the operational array mat. After orthogonal memory 160 stores all the transferred data, i.e., 64 pieces of data, horizontal word lines WLH are sequentially selected to transfer the data from orthogonal memory 160 to the memory cell mat in the operational array mat. In the operational array mat, the transferred data bits are written at the respective locations of the eight entries.

In the data mapping as shown in FIG. 34, therefore, the memory storage state similar to the data storage state in orthogonal memory 160 is achieved in the memory cell mat of the operational array mat, and the mapping of the data transferred via the system bus onto the memory cell mat can be desirably changed.

The construction of the address generating unit shown in FIG. 33 can be also utilized for generating the addresses for data writing into orthogonal memory 160 shown in FIG. 34, and for data transfer to the operational array mat. Specifically, address generating circuit 167 shown in FIG. 33 is configured to generate the row and column addresses. As for the column address, the word driver group of write drivers to be activated may merely be activated sequentially on a group-by-group basis (i.e., a group of word drivers (write drivers) of the data bit width at a time). In this construction, it is not necessary to generate the column address, but is required to generate a block select signal for designating a word (write) driver group in a predetermined sequence.

The sequence of activating horizontal word lines WLH can be changed. Thus, in storing the data stored in entries ENT0-ENT7, in the memory cell mat of the operational array mat, it is possible to change the sequence of storing the data in the corresponding entries in the memory cell mat of the operational array mat, and the mapping of the external data onto the data in the operational array mat can be changed more flexibly.

[Modification 2]

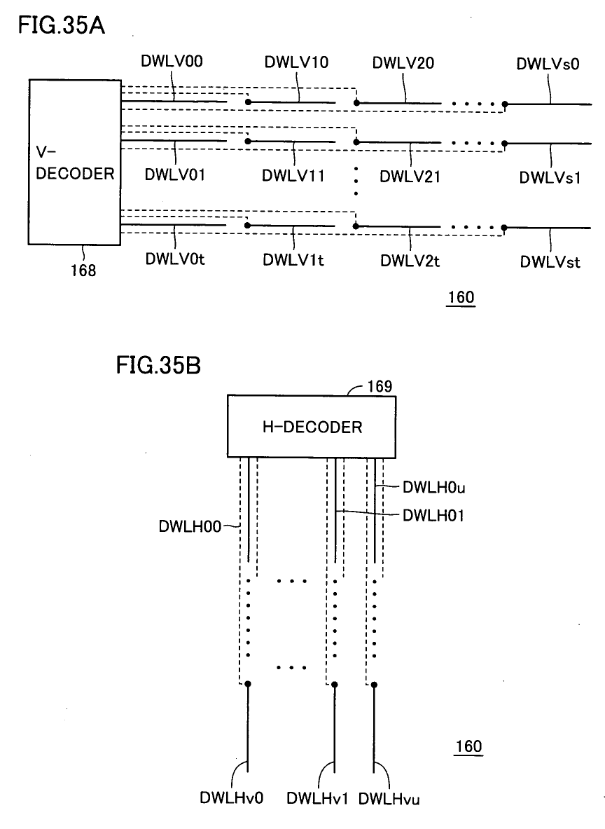

FIGS. 35A and 35B schematically show an array construction of an orthogonal memory according to a second modification of the sixth embodiment of the invention. In FIG. 35A, vertical word line WLV in each row (entry) is divided into a plurality of divided word lines DWLV. In FIG. 35A, (s+1) divided word lines are arranged in each row, and divided word lines DWLV00-DWLVs0, DWLV01-DWLVs1, . . . and DWLV0t-DWLVst are shown as representative.

These divided word lines are driven to the selected state according to the select signal supplied from V-decoder 168. In each row (entry), V-decoder 168 drives one divided word line to the selected state. Each of divided word lines DWLV00-DWLVst may be connected to a plurality of two-port memory cells, or alternatively may be connected to a two-port memory cell of one bit.

In FIG. 35B, each word line DWLH in orthogonal memory 160 is likewise divided vertically into a plurality of divided word lines DWLH. FIG. 35B shows divided word lines DWLH00-DWLH0u, . . . DWLHv0-DWLHvu as representative. These divided word lines DWLH00-DWLHvu are driven to the selected state according to the select signal supplied from an H-decoder 169. H-decoder 169 drives one divided word line DWLH in each column (in the extension direction of the bit line BLH) to the selected state. One divided word line DWLH may be connected to the two-port memory cell of one bit, or may be connected to the two-port memory cells of multiple bits.

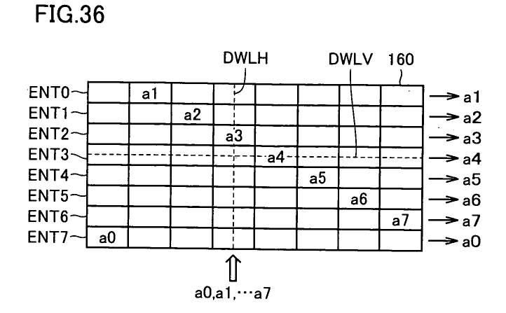

FIG. 36 shows by way of example a storage state of the data in orthogonal memory 160. In the example shown in FIG. 36, orthogonal memory 160 is vertically divided into eight entries ENT0-ENT7. Data train of data a0-a7 are supplied in parallel to orthogonal memory 160. Divided word lines DWLV are each arranged in entries ENT0-ENT7. V-decoder 168 shown in FIG. 35A selects divided word lines DWLV such that data a0 is stored in entry ENT7, and data a1-a7 are stored at the different bit address positions in the entries ENT0-ENT6, respectively.

For transferring the data onto the main computational circuit (operational array mat), H-decoder 169 shown in FIG. 35B drives divided word line DWLH to the selected state so that data train a1-a7 and a0 can be sequentially read in bit serial. Therefore, by dividing the word lines in the memory array of orthogonal memory 160, the data arrangement can be easily changed in orthogonal memory 160.

V-decoder 168 and H-decoder 169 are supplied with the addresses indicating the entries as well as the information indicating the selected bit positions in the entries so that each divided word line can be driven to the selected state,

Each of divided word lines DWLH and DWLV may be connected to one two-port memory cell, and alternatively may be connected to the plurality of two-port memory cells.

As described above, the word lines in the orthogonal memory have the divided structures so that the data arrangement can be easily transformed. When orthogonal memory 160 operates to change the arrangement of data transferred from the main computational circuit (or operational array mat) for transferring the data to the system bus, the data is transferred and transformed in the flow opposite to the data flow shown in FIG. 36.

The address generating circuit may be implemented by the controller (21) producing the select bit position information in each entry based on the address sequence information for each entry.

According to the sixth embodiment of the invention, as described above, the data sequence is changed in the orthogonal memory, and external data can easily be stored, with the address mapping changed, in the memory cell mat of the main computational circuit.

### Seventh Embodiment

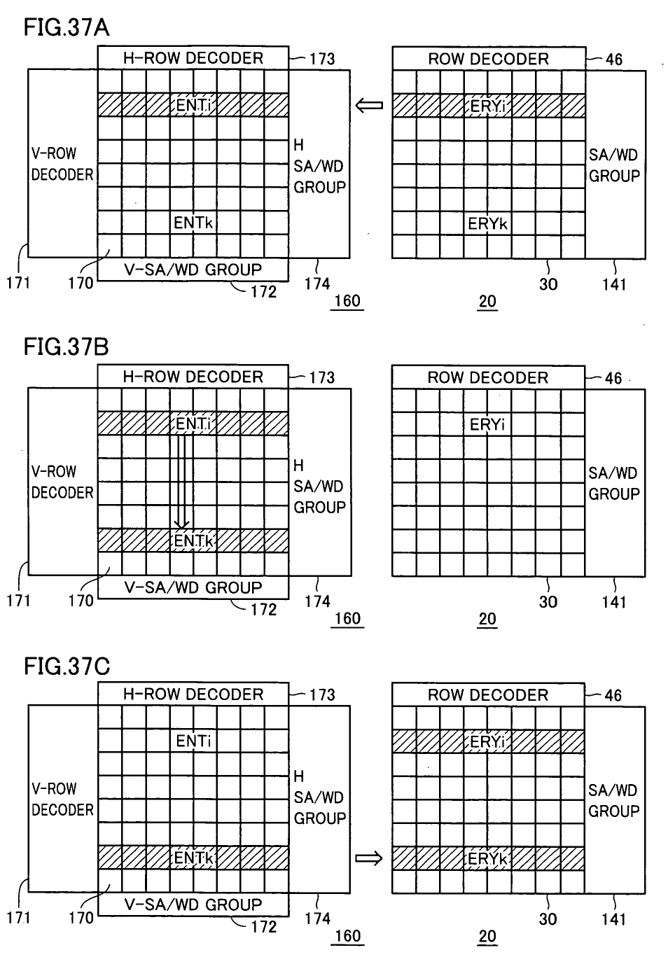

FIGS. 37A-37C illustrate an example of the data transfer operation according to a seventh embodiment of the invention. In the seventh embodiment, data in entry ERYi of memory cell mat 30 in main computational circuit 20 are copied into entry ERYk. For this memory cell mat 30, row decoder 46 as well as sense amplifier and write driver (SA/WD) group 141 are provided. Row decoder 46 selects a word line arranged perpendicularly to the entry. Therefore, orthogonal memory 160 is utilized when so-called copy processing of transferring the data in entry ERYi to entry ERYk is performed in the main computational circuit 20.

Similarly to the embodiments already described, orthogonal memory 160 includes a memory cell mat 170 having two-port memory cells arranged in rows and columns, a V-row decoder 171 for selecting a word line (WLV) arranged for an entry ENT in memory cell mat 170, an H-row decoder 173 for selecting a word line (WLH) arranged perpendicularly to the entry ENT, a V-SA/WD (sense amplifier and write driver) group 172 for internally performing the write/read of data on an entry-by-entry basis and an H-SA/WD (sense amplifier and write driver) group 174 providing the interface for transferring the data with main computational circuit 20.

An input/output buffer circuit for performing input/output of data in orthogonal memory 160 is not depicted in the figures.

In the data transfer operation, it is first necessary to transfer the data of copy target entry ERYi in main computational circuit 20 as illustrated in FIG. 37A. Therefore, row decoder 146 successively selects the word lines (not shown), and transfers the data via the internal data bus to orthogonal memory 160. In orthogonal memory 160, H-row decoder 173 successively selects the word lines, and the data applied via the write driver in HSA/WD group 174 are stored in entry ENTi on the bit-by-bit basis. This bit-serial data transfer operation is repeated until the copy data (an entire or a part of data) in entry ERYi is transferred.

After all the data is transferred from a copy source to orthogonal memory 160, V-row decoder 171 drives the word line corresponding to entry ENTi to the selected state in orthogonal memory 160, and sequentially activates the sense amplifiers and the write drivers in V-SA/WD group 172. Then, V-row decoder 171 selects the word line arranged corresponding to entry ENTk of the copy destination. Thereby, the data in entry ENTi amplified by V-SA/WD group 172 is stored in entry ENTk.

When the data transfer operation is completed in orthogonal memory 160, H-row decoder 173 sequentially drives word lines (WLH) to the selected state as shown in FIG. 37C, and then sense amplifiers (SA) in H-SA/WD group 174 are activated. Thereby, the data in entry ENTk is transferred in the bit serial fashion to main computational circuit 20, and the transferred data is stored in memory cell mat 30 of main computational circuit 20 by activating the write driver (WD) in SA/WD group 141. In this case, row decoder 46 successively drives the word lines to the selected state in memory cell mat 30, and the data is transferred in the bit serial fashion between orthogonal memory 160 and main computational circuit 20.

When the data in entry ENTk of orthogonal memory 160 are stored in entry ERYk of memory cell mat 30 in main computational circuit 20, main computational circuit 20 is in such a state that the data in entry ERYi of memory cell mat 30 have been transferred to entry ERYk, and the copy operation is completed.

In the data transferring operation as illustrated in FIGS. 37A-37C, the data transfer between orthogonal memory 160 and main computational circuit 20 is performed via the internal data bus, and therefore the data of the width corresponding to the bit width of the internal data bus is transferred. However, even when the data in the entries other than entries ERYi and ERYk is transferred, the data returned from orthogonal memory 160 are the same as the original data except the data in entry ERYk. Thus, rewriting of the data is merely performed, and the contents in the entries do not change (except entry ERYk). Even when the data transfer is performed via the internal data bus in the entry parallel and bit serial fashion, the data transfer between the copy source and copy destination is performed in orthogonal memory 160, and thus the data in entry ERYi can be reliably copied into entry ERYk without an adverse influence on storage contents of the other entries in main computational circuit 20.

The following data transfer sequence may be employed. Specifically, for the data transfer from main computational circuit 20 to orthogonal memory 160, the sense amplifiers in sense amplifier and write driver group 141 for the block including entry ERYi are activated, and the write drivers are likewise activated in H-SA/WD group 174 in a block division fashion for a block including the entry ENTi. For the data transfer from orthogonal memory 160 to main computational circuit 20, the sense amplifiers and the write drivers are activated in H-SA/WD group 174 and SA/WD group 141 for the block including entries ENTk and ERYk, respectively. According to such data transfer sequence, current consumption in the copy operation can be reduced.

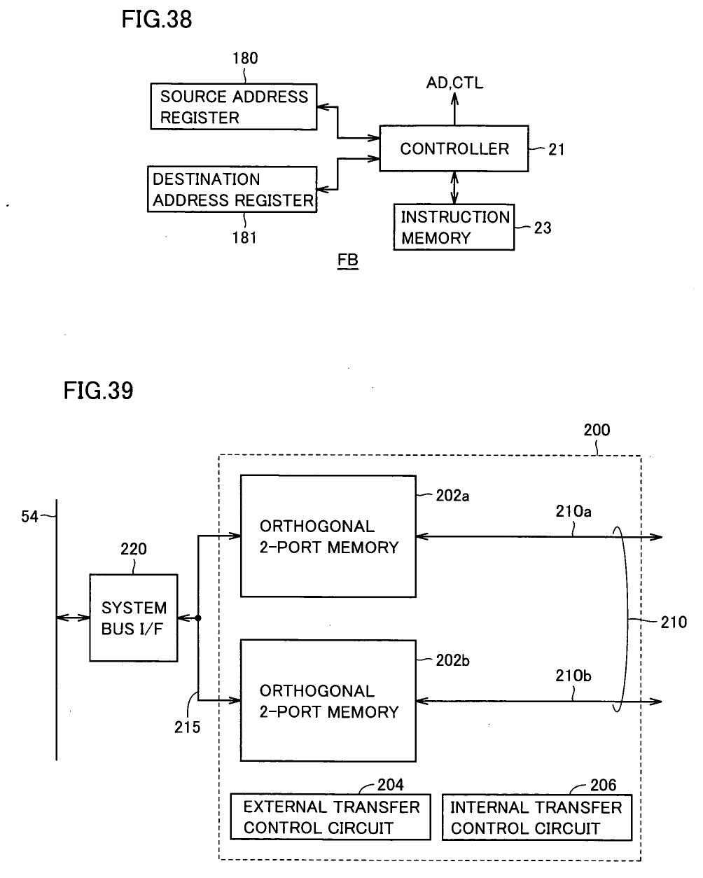

FIG. 38 schematically shows a construction of a portion for controlling the copy operation illustrated in FIGS. 37A-37C. In FIG. 38, there are provided, as a copy operation control unit, a source address register 180 for storing an entry address of a copy source, a destination address register 181 for storing an entry address of a copy destination and controller 21 for producing an address AD and a control signal CTL in response to the copy instruction supplied from instruction memory 23 and based on the addresses stored in registers 180 and 181.

Controller 21 in fundamental operational block FB is used for controlling the sense amplifiers and the write drivers in the main computational circuit (20) with control signal CTL, and the entry select address of V-row decoder (171) of orthogonal memory 160 is set according to address signal AD. According to control signal CTL supplied from controller 21, the read/write operation is performed in orthogonal memory 160. The controller 21 controls the copy operation according to the micro-program instruction stored in the instruction memory 23. In this operation, controller 21 calculates the entry addresses of the copy source and copy destination, and stores the source entry address and destination entry address in source and destination address registers 180 and 181, respectively. Theses registers 180 and 181 are those originally provided in the main computational circuit.

When this copy operation is effected on only a part of the data in entry ERY (e.g., only the operational processing result data), source address register 180 stores the entry address and the transfer data storage region designating an address within this entry. Based on the address designating such partial data region, the word line selecting range of row decoder 46 in main computational circuit 20 is set.

Destination address register 181 may likewise store the entry address and the copy data storage region designating address.

According to the seventh embodiment of the invention, as described above, the orthogonal memory is used for transferring the data with the memory cell mat of main computational circuit 20, so that the copying of desired data in the memory cell mat of the main computational circuit can be internally executed.

### Eighth Embodiment

FIG. 39 schematically shows a construction of an orthogonal memory according to an eighth embodiment of the invention. In FIG. 39, an orthogonal memory 200 includes orthogonal two-port memories 202a and 202b operating individually and separately from each other, an a to-outside transfer control circuit 204 for controlling the data transfer between orthogonal memory 200 and a system bus I/F 220, an a to-inside transfer control circuit 206 controlling the data transfer between an internal data bus 210 and orthogonal two-port memories 202a and 202b.

Orthogonal two-port memories 202a and 202b are commonly coupled to system bus I/F 220 via an internal bus 215, and performs the data transfer with system bus 54.

Each of orthogonal two-port memories 202a and 202b has substantially the same construction as orthogonal memory 80 shown in FIG. 12. Thus, each of orthogonal two-port memories 202a and 202b includes a port (V-port) for transferring the data with system bus I/F, and a port (H-port) for transferring the data with the fundamental operational block (main computational circuit) via a sub-data bus 210a or 210b. Data transfer control circuits 204 and 206 operate these orthogonal two-port memories 202a and 202b in an interleaving fashion.

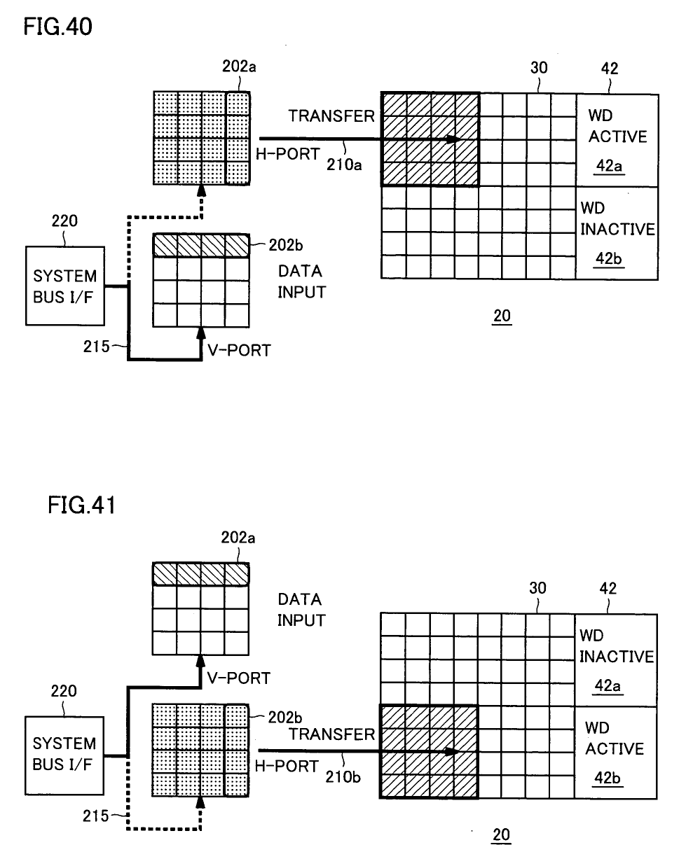

FIGS. 40 and 41 schematically illustrate a flow of data in orthogonal memory 200 shown in FIG. 39. Referring to FIGS. 40 and 41, the data transfer operation of orthogonal memory 200 shown in FIG. 39 will now be described.

Orthogonal two-port memory 202a stores the data via system bus I/F 220. When orthogonal two-port memory 202a attains a full state, the V-port of orthogonal two-port memory 202b is made active to store successively the data supplied from system bus I/F 220 via internal data bus 215. In parallel to the data writing into orthogonal two-port memory 202b, the H-port (the sense amplifiers and output circuit) of orthogonal two-port memory 202a is made active to transfer successively the data to memory cell mat 30 of main computational circuit 20 via sub-data bus 210a. In main computational circuit 20, a word driver (write driver WD) sub-group 42a corresponding to sub-data bus 210a in word (write) driver group 42, and word driver (write driver) WD in word (write) driver sub-group 42b is kept inactive. Thereby, the bit serial data is successively stored only in the entries corresponding to the sub-data bus 210a via the word (write) driver (WD) from orthogonal two-port memory 202a.

Then, as shown in FIG. 41, orthogonal two-port memory 202b attains a full state of data available for transfer, and the data transfer operation of orthogonal two-port memory 202a is completed. Accordingly, the V-port of orthogonal two-port memory 202a is made active, to successively store the data transferred from system bus I/F 220 via internal data bus 215. In parallel, the H-port of orthogonal two-port memory 202b is made active, to transfer the storage data to the main computational circuit via sub-data bus 210b. In main computational circuit 20, word drivers WD of word driver sub-group 42b corresponding to internal sub-data bus 210b are made active to amplify the transferred data for storage in the corresponding entries. Word drivers WD in word driver sub-group 42a corresponding to sub-data bus 210a are inactive, and therefore, even when the word line in memory cell mat 30 is driven to the selected state commonly to the entries, the transferred data can be reliably stored without adversely affecting the data already transferred.

Thereafter, the data input and data transfer for orthogonal two-port memories 202a and 202b are alternately repeated until the required data are all transferred.

For transferring the data to the operational array mat (main computational circuit) by using the orthogonal memory, it is necessary to transfer the data by transforming the word serial and bit parallel data into the bit serial and word parallel data. Therefore, after the data is input from the system bus to the orthogonal memory and all the transferred data are stored in the orthogonal memory, the data is transferred to the operational array mat (main computational circuit). In the foregoing interleaving transfer sequence, even when the data is being transferred from the orthogonal memory to memory cell mat 30 of the operational array mat (or main computational circuit), the data supplied from the system bus can be input with another orthogonal two-port memory. Thus, even when a large quantity of data such as image data is successively supplied from the system bus, the data transfer can be performed without lowering the data transfer rate, and the advantageous feature of the parallel operational processing function can be prevented from being impaired due to increase in data transfer time.

For transferring the data from the main computational circuit or operational array mat to orthogonal memory 200, the data may be transferred in parallel from all the entries of memory cell mat 30 to be stored in parallel via the H-ports of orthogonal two-port memories 202a and 202b, and thereafter the data may be transferred onto the system bus in an interleaving fashion with respect to orthogonal memories 202a and 202b. Alternatively, the data transfer may be performed in the direction opposite to the data transfer direction as shown in FIGS. 40 and 41 (sense amplifier groups in memory cell mat of the main computational circuit are activated for each group corresponding to sub-data bus 210a or 210b).

Orthogonal two-port memories 202a and 202b of orthogonal memory 200 are merely required to operate individually and separately from each other, and may be configured using a bank configuration. Also, orthogonal two-port memories 202a and 202b may be driven according to a block-divided driving scheme (i.e., the H- and V-ports are activated block by block in the interleaved fashion).

Controller (21) included in the main computational circuit performs the control of activation/deactivation of the word drivers (write drivers) WD on an entry group basis (sub-data bus basis). In this case, it is merely required that controller (21) is supplied with the information indicating which of internal sub-data buses 210a and 210b is utilized from to-inside transfer control circuit 206 in orthogonal memory 200 shown in FIG. 39, and selectively activates the word drivers based on the transferred sub-data bus indicating information.

Alternatively, when transferring the operational processing data to memory cell mat 30, the order of use of sub-data buses 210a and 210b may be predetermined, and the word drivers WD may be selected and activated on the sub-group basis (i.e., sub-group by sub-group) in the predetermined order.

According to the eighth embodiment of the invention, as described above, the orthogonal memory is formed of the two orthogonal two-port memories operating individually and separately from each other, and these memories can be used in an interleaved fashion to perform the input and transfer of data. The data can be transferred successively from the system bus without interruption, so that the data transfer rate for the fundamental operational block can be kept high, and the operational processing time can be reduced.

### Ninth Embodiment

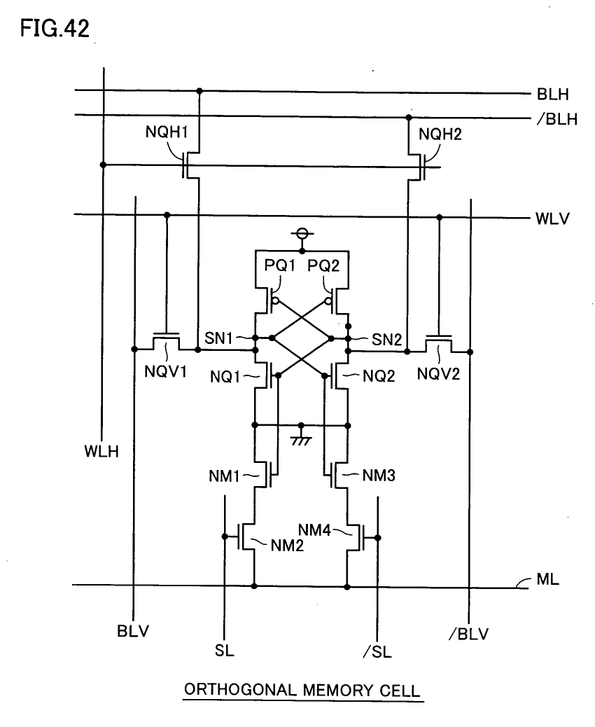

FIG. 42 shows a configuration of an orthogonal memory cell used in an orthogonal memory according to a ninth embodiment of the invention. The orthogonal memory cell shown in FIG. 42 has, in addition to the configuration of the orthogonal two-port memory cell shown in FIG. 11, a construction for detecting matching of the stored data. Specifically, a data retrieving unit in the orthogonal memory cell includes N channel MOS transistors NM1 and NM2 connected in series between a ground node and a match line ML, and N channel MOS transistors NM3 and NM4 connected in series between the ground node and match line ML. MOS transistors NM1 and NM3 have gates connected to storage nodes SN2 and SN1, respectively. MOS transistors NM2 and NM4 have gates connected to search lines SL and /SL transmitting the search data, respectively.

Other configurations of the orthogonal memory cell shown in FIG. 42 are the same as those of the orthogonal memory cell shown in FIG. 11. Corresponding portions are allotted with the same reference characters, and description thereof is not repeated.

The orthogonal memory cell shown in FIG. 42 is a content addressable memory cell (CAM cell). When the data stored on storage nodes SN1 and SN2 match with search data appearing on search lines SL and /SL, one of MOS transistors NM1 and NM2 is in an off state, and one of MOS transistors NM3 and NM4 is in an off state. Therefore, match line ML is kept in a precharged state (e.g., at an H level). When the search data transmitted onto search lines SL and /SL is different in logic from the stored data on storage nodes SN1 and SN2 of the orthogonal memory cell, both MOS transistors NM1 and NM2 are in an on state, or both MOS transistors NM3 and NM4 are in an on state. In this case, therefore, match line ML is discharged to the ground voltage level. By externally detecting the voltage level of the match line ML, it is possible to determine match/mismatch of the search data with the stored data in the orthogonal memory cell. Match line ML is arranged parallel to vertical word line WLV. Therefore, when the stored bits in one entry of the orthogonal memory (i.e., the stored bits in memory cells selected by a vertical word line WLV) match with all the search data bits, match line ML is maintained at the H level of the precharge voltage level.

The orthogonal memory cell is of a two-port memory cell structure, and can transform the data train similarly to the orthogonal memory cell shown in FIG. 11.

When utilizing the orthogonal memory cell as shown in FIG. 42, the orthogonal memory can have a function of CAM (Content Addressable Memory), in addition to the data arrangement transforming function, and can achieve the data searching function.

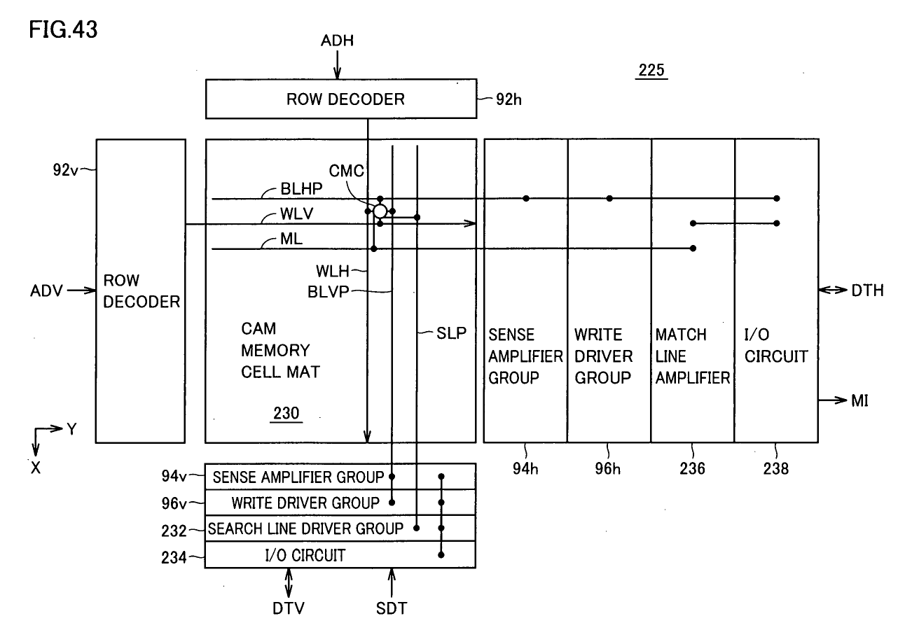

FIG. 43 schematically shows a construction of the orthogonal memory according to a ninth embodiment of the invention. In FIG. 43, an orthogonal memory 225 includes a CAM memory cell mat 230 having CAM cells (orthogonal memory cells) CMC arranged in rows and columns. In CAM cell mat 230, there are provided a word line WLH, a bit line pair BLVP and a search line pair SLP, all being arranged corresponding to each line of CAM cells CMC aligned in the X direction, as well as a bit line pair BLHP, a word line WLV and a match line ML all being arranged corresponding to each line of CAM cells CMC aligned in the Y direction.

Similarly to the orthogonal memory shown in FIG. 12, orthogonal memory 220 further includes row decoder 92v for selecting word line WLV according to V-direction word address ADV, row decoder 92h for selecting word line WLH according to H-direction word address ADH, sense amplifier group 94v for amplifying the data read onto bit line pairs BLVP for transmission to an input/output circuit 234, write driver group 96v for driving bit line pairs BLVP according to write data supplied from input/output circuit 234, a search line driver group 232 for driving the search line pairs SLP according to search data SDT supplied from input/output circuit 234, sense amplifier group 94h for amplifying the data on bit line pairs BLP for transmission to an input/output circuit 238, write driver group 96h for driving bit line pairs BLHP according to data supplied from input/output circuit 238 according to H-direction data DTH, and a match line amplifier 236 for amplifying the signals on match lines ML.

Input/output circuit 234 is supplied with transfer data DTV and search data SDT from the system bus. Data DTV and SDT may be supplied via different paths, respectively, or may be provided via a common internal data bus. FIG. 43 shows a construction in which data DTV and SDT are supplied via different paths, respectively.

Input/output circuit 238 produces transfer data DTH for the main computational circuit (operational array mat), and further produces match information MI based on a match line signal generated from a match line amplifier 236. Match information MI may be supplied to a controller included in the main computational circuit of the fundamental operational block, and may be transferred from orthogonal memory 225 via the external system bus.

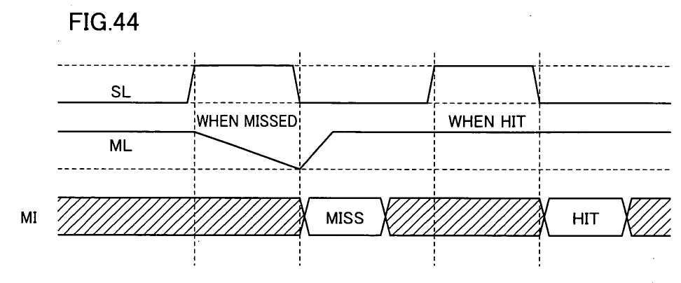

FIG. 44 is a signal waveform diagram representing a searching operation in orthogonal memory 225 shown in FIG. 43. The operation of reading data DTH and DTV is the same as that of the orthogonal memory shown in FIG. 12, and the read operation similar to that of a standard SRAM is effected on each of H- and V-direction data.

FIG. 44 shows by way of example an operation waveform in the case where H level data of one bit is transmitted to a search line SL as search data SDT.

When search data SDT is supplied to search line driver group 232 via input/output circuit 234, the search line driver in the search line driver group drives a corresponding search line pair SLP according to this search data. When search line SL shown in FIG. 42 is at the H level, and mismatches with the stored data in the CAM cell (orthogonal memory cell) (upon MISS), storage node SN2 is at the H level, and storage node SN1 is at the L level. Therefore, both MOS transistors NM1 and NM2 in the CAM cell (orthogonal memory cell) shown in FIG. 42 are conductive to drive match line ML to the ground voltage level. A match line amplifier 260 amplifies the information on match line ML, and transmits thus amplified signal to input/output circuit 238. According to the voltage levels on all match lines ML, match information (match/mismatch information) is set to the state indicating mismatching “MISS”.

When search data SDT matches with the stored data in CAM cell CMC connected to match line ML, search lines SL and /SL in CAM cell (orthogonal memory cell) shown in FIG. 42 are at the L and H levels, respectively, and storage nodes SN1 and SN2 are at the H and L levels, respectively. Therefore, both MOS transistors NM1 and NM4 are in an off state, and the discharge path of match line ML does not exist. When all the CAM cells connected to this match line ML are in the matching state, the discharge path of this match line ML does not exist, and match line ML is kept at the H level when matching with the search data occurs (i.e., upon “HIT”). Thus, based on the information supplied from match line amplifier 236, match information MI generated from input/output circuit 238 is set to the state HIT representing matching.

In the orthogonal memory, therefore, the CAM cell is utilized as the orthogonal memory cell, and each fundamental operational block can have a data search function (when orthogonal memory 225 is provided for each fundamental operational block). In this case, therefore, the fundamental operational block can implement the function of executing or not executing the processing only when the data matching with search data SDT is present in orthogonal memory 225, and can also implement the function of externally transferring the data or executing another operational processing only when data matching with search data SDT is present in the processing result data.

The matching information may be configured to include an address information on the matching match line ML by detecting the match line ML exhibiting MATCH. Thus, the orthogonal memory can be utilized as the CAM, and it is possible to implement the processing of outputting externally the entry address corresponding to the search data and reading the data at the matched address from the external memory.

According to the ninth embodiment of the invention, as described above, the two-port CAM cell is used in the orthogonal memory for the data arrangement transformation, so that the semiconductor signal processing device can have the data search function.

Orthogonal memory 225 may be provided for each of the fundamental operational blocks, or may be provided commonly to the plurality of fundamental operational blocks.

The semiconductor signal processing device according to the invention can be applied to the processing system processing a large quantity of data, and can be used for fast processing of data such as image data or audio data.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A semiconductor signal processing device comprising:
at least one fundamental operational block including a memory cell mat divided into a plurality of entries each having a plurality of memory cells, and a plurality of processing units, arranged corresponding to the entries of said memory cell mat, each being capable of performing an operational processing on data of a corresponding entry and storing a result of said the operational processing in the corresponding entry, each of said entries storing bits of a same multi-bit data;
an internal data transfer bus for transferring data of a larger bit width than external transfer data outside the device with the memory cell mat of the fundamental operational block;
an interface unit for providing an external interface with an outside of the device;
data arrangement transforming circuitry arranged between said interface unit and said internal data transfer bus for rearranging the data between said interface unit and said internal data transfer data bus,
said data arrangement transforming circuitry including
a plurality of first word lines arranged extending in a first direction in which the entries extends,
a plurality of second word lines arranged extending in a second direction crossing the first direction,
a plurality of first bit line pairs arranged extending in said second direction,
a plurality of second bit line pairs arranged extending in said first direction, and
a memory array having a plurality of Static Random Access Memory (SRAM) cells arranged being aligned in the first and second directions into an array form and located corresponding to crossings of the first word lines and the first bit line pairs and crossings of the second word lines and the second bit line pairs, the first word lines being arranged corresponding to the second bit line pairs, and the second word lines being arranged corresponding to the first bit line pairs,
first cell selecting circuitry for selecting a first word line in the first word line and a fist bit line pair among the first bit line when data is transferred with said interface unit, and
second cell selecting circuitry for selecting a second word line in the second word lines and a second bit line in the second bit line pair when the data is transferred with said internal data transfer bus.

2. The semiconductor signal processing device according to claim 1, wherein
said at least one fundamental operational block comprises a plurality of fundamental operational blocks coupled in parallel to said internal data transfer bus.

3. The semiconductor signal processing device according to claim 1, further comprising:
a bus width changing circuit arranged between said data arrangement transforming circuitry and said internal data transfer bus, for changing a data bus width.

4. The semiconductor signal processing device according to claim 1, wherein
said first cell selecting circuitry selects data of a first data bit width, and
said second cell selecting circuitry selects data of a second bit width larger than said first data bit width.

5. The semiconductor signal processing device according to claim 1, wherein
said at least one fundamental operational block includes a plurality of fundamental operational blocks, and
said data arrangement transforming circuitry is arranged corresponding to each of the fundamental operational blocks.

6. The semiconductor signal processing device according to claim 1, wherein
said at least one fundamental operational block includes a plurality of fundamental operational blocks, and
said internal data transfer line is arranged extending over the memory cell mats of said plurality of fundamental operational blocks, and commonly to said plurality of fundamental operational blocks.

7. The semiconductor signal processing device according to claim 1, wherein
said data arrangement transforming circuitry further includes a circuit for changing an address of data external to the device for storage in said memory array.

8. The semiconductor signal processing device according to claim 1, wherein
said memory array having the plurality of SRAM cells is divided into first and second sub-memory mats, and
the first and second cell selecting circuits each access the first and second sub-memory mats in an interleaving fashion, and when one of the first and second cell selecting circuits selects the first sub-memory mat, the other cell selecting circuit selects the second sub-memory mat.

9. The semiconductor signal processing device according to claim 1, wherein
the memory array of the SRAM cells further includes:
a plurality of detecting elements arranged corresponding to the SRAM cells each for determining match or mismatch of stored data in corresponding SRAM cells with search data, and
a plurality of match lines each arranged corresponding to the detecting elements aligned in said first direction, and being driven according to results of detection of corresponding detecting elements.

10. A semiconductor signal processing device comprising:
a fundamental operational block including a memory array divided into a plurality of entries each having a plurality of memory cells aligned in a first direction, and a plurality of operational processing units, arranged corresponding to the entries of said memory array, each being capable of performing an operational processing on data of a corresponding entry and of storing a result of the operational processing in the corresponding entry, each of said entries storing bits of same multi-bit data;
data arrangement transforming circuitry arranged adjacently and corresponding to said memory array for rearranging the data between an internal data bus and said memory array,
said data arrangement transforming circuitry including:
a plurality of first word lines arranged corresponding to the entries,
a plurality of second word lines arranged extending in a second direction crossing the first direction,
a plurality of first bit line pairs arranged extending in said second direction,
a plurality of second bit line pairs arranged extending in said first direction and corresponding to the entries, and
a memory cell array having a plurality of Static Random Access Memory (SRAM) cells arranged being aligned in the first and second directions into an array form and located corresponding to crossings of the first word lines and the first bit line pairs and crossings of the second word lines and the second bit line pairs, the first word lines being arranged corresponding to the second bit line pairs, and the second word lines being arranged corresponding to the first bit line pairs,
first cell selecting circuit for selecting a first word line in the first word lines and a fist bit line pair in the first bit line pairs when data is transferred with said internal data bus,
second cell selecting circuit for selecting a second word line in the second word lines and a second bit line pair in the second bit line pairs when the data is transferred with r from the memory array of the fundamental operational block, and
data transferring circuit for transferring data between the entries and corresponding second bit lines.

11. The semiconductor signal processing device according to claim 10, wherein
the second bit line pairs each continuously extends through the corresponding entry to be shared between the memory array and the memory cell array.

12. The semiconductor signal processing device according to claim 10, wherein
the memory cell array of said plurality of SRAM cells is divided into first and second sub-memory mats, and
the first and second cell selecting circuits access the first and second sub-memory mats in an interleaving fashion, and when one of said first and second cell selecting circuits selects the first sub-memory mat, the other cell selecting circuit selects the second sub-memory mat.

13. The semiconductor signal processing device according to claim 10, wherein
said memory cell array of the SRAM cells further includes:
a plurality of detecting elements arranged corresponding to the SRAM cells for determining match or mismatch of stored data in corresponding SRAM cells with search data, and
a plurality of match lines each arranged corresponding to the detecting elements aligned in said first direction, and being driven according to results of detection of corresponding detecting elements.
